(19) United States
(12) Patent Application Publication
(10) Pub. No.: US 2024/0396433 A1
(43) Pub. Date: Nov. 28, 2024

(54) SWITCHING POWER CONVERTERS CONFIGURED TO INJECT CURRENT INTO AN OUTPUT NODE

(71) Applicant: Maxim Integrated Products, Inc., San Jose, CA (US)

(72) Inventor: Alexandr Ikriannikov, San Jose, CA (US)

(21) Appl. No.: 18/630,129

(22) Filed: Apr. 9, 2024

Related U.S. Application Data
(60) Provisional application No. 63/503,644, filed on May 22, 2023.

(51) Int. Cl. H02M 1/14; H02M 1/44; H02M 3/158

(52) U.S. Cl. CPC H02M 1/14; H02M 1/44; H02M 3/1584

(57) ABSTRACT

A switching power converter includes a plurality of power stages and a blocking capacitor. Each power stage includes a respective power transformer. The blocking capacitor and a respective secondary winding of each power transformer are electrically coupled in series between an output power node of the switching power converter and a reference node of the switching power converter. Another switching power converter includes a plurality of power stages, a boost winding, and a blocking capacitor. Each power stage includes a respective power transfer winding, and the boost winding forms at least one turn around a respective leakage magnetic flux path of each power transfer winding. The blocking capacitor and the boost winding are electrically coupled in series between an output power node of switching power converter and a reference node of the switching power converter.

### RELATED APPLICATIONS

This application claims benefit of U.S. Provisional Patent Application No. 63/503,644, filed on May 22, 2023, which is incorporated herein by reference.

### BACKGROUND

Switching power converters are widely used in electronic devices, such as to provide a regulated electrical power source. A switching power converter is configured such that its solid-state power switching devices do not continuously operate in their active states; instead, the switching devices repeatedly switch between their on-states and off-states. Although switching power converters can achieve high efficiency, particularly under heavy load conditions, they typically exhibit ripple current due to switching action of their switching devices. Ripple current is generally undesirable because it causes power losses and ripple voltage. Additionally, switching power converters may not respond to a transient loading event as quickly as desired due to time required to change amount of energy stored in one or more energy storage devices, e.g., inductors and/or capacitors, of switching power converters. Speed at which a switching power converter is capable of responding to a change in load powered by the switching power converter is referred to as “transient response” of the switching power converter. As such, the faster the transient response of a switching power converter, the quicker the switching power converter can respond to a change in load.

Some switching power converters include one or more transformers. A transformer exhibits magnetizing inductance and leakage inductance. Magnetizing inductance is inductance associated with magnetic flux linking the primary and secondary windings, while leakage inductance is inductance associated with magnetic flux generated by current flowing through one of the primary and secondary windings that does not couple to any other winding of the transformer.

Additionally, some switching power converters include one or more discrete inductors, where a discrete inductor is an inductor that is not magnetically coupled to any other inductor. Furthermore, some switching power converters include one or more coupled inductors, where a coupled inductor is a device including two or more inductors that are magnetically coupled. A coupled inductor exhibits magnetizing inductance, which is inductance associated with magnetic flux linking the windings of the coupled inductor. Additionally, each winding of a coupled inductor exhibits leakage inductance, which is inductance associated with magnetic flux that flows only around the particular winding, i.e., magnetic flux that does not couple to any other winding. A coupled inductor is typically designed to have a finite leakage inductance, such as to achieve a desired ripple currently magnitude and/or transient response, while a transformer is typically designed to minimize leakage inductance.

### BRIEF DESCRIPTION OF THE DRAWINGS

FIG. 1 is a schematic diagram of a multi-phase switching power converter including transformers, where the switching power converter is configured to inject current into an output power node of the switching power converter to help minimize ripple current magnitude, according to an embodiment.

FIG. 2 illustrates one possible implementation of switching stages of the FIG. 1 switching power converter, according to an embodiment.

FIGS. 3A and 3B include respective graphs illustrating simulated operation of one embodiment of the FIG. 1 switching power converter.

FIGS. 4A and 4B include respective graphs illustrating simulated operation of another embodiment of the FIG. 1 switching power converter.

FIG. 5 is a graph of current versus time illustrating simulated operation of an embodiment of the FIG. 1 switching power converter in response to a change in load.

FIG. 6 is a schematic diagram of an alternate embodiment of the FIG. 1 switching power converter that is optimized for fast transient response instead of being optimized for low ripple current magnitude.

FIG. 7 is a graph of current versus time illustrating simulated operation of an embodiment of the FIG. 1 switching power converter in response to a change in load.

FIG. 8 is a schematic diagram of a multi-phase switching power converter including a boost winding, where the switching power converter is configured to inject current into an output power node of the switching power converter to help minimize ripple current magnitude, according to an embodiment.

FIG. 9 is a perspective view of a boosted coupled inductor, according to an embodiment.

FIG. 10 is an elevational view of a side of the FIG. 9 boosted coupled inductor.

FIG. 11 is a top plan view of the FIG. 9 boosted coupled inductor.

FIG. 12 is a cross-sectional view of the FIG. 9 boosted coupled inductor.

FIG. 13 is another cross-sectional view of the FIG. 9 boosted coupled inductor.

FIG. 14 is a top plan view of the FIG. 9 boosted coupled inductor with windings omitted.

FIG. 15 is a top plan view of the FIG. 9 boosted coupled inductor that is marked up to show several example mutual magnetic flux paths.

FIG. 16 is a perspective view of the FIG. 9 boosted coupled inductor that is marked up to show a few examples of leakage magnetic flux paths.

FIG. 17 is a top plan view of an alternate embodiment of the FIG. 9 boosted coupled inductor.

FIG. 18 is a cross-sectional view of the FIG. 17 boosted coupled inductor.

FIG. 19 is a perspective view of an alternate embodiment of the FIG. 9 boosted coupled inductor further including leakage elements.

FIG. 20 is a perspective view of an alternate embodiment of the FIG. 19 boosted coupled inductor.

FIG. 21 is a cross-sectional view of the FIG. 20 boosted coupled inductor.

FIG. 22 is a top plan view of an alternate embodiment of the FIG. 20 boosted coupled inductor.

FIG. 23 is a cross-sectional view of the FIG. 22 boosted coupled inductor.

FIG. 24 is a top plan view of the FIG. 22 boosted coupled inductor with windings omitted.

FIG. 25 is a top plan view of the FIG. 22 boosted coupled inductor including two leakage elements.

FIG. 26 is a cross-sectional view of the FIG. 25 boosted coupled inductor.

FIG. 27 is a top plan view of the FIG. 25 boosted coupled inductor with windings omitted.

FIG. 28 is a perspective view of a non-scalable boosted coupled inductor, according to an embodiment.

FIG. 29 is a perspective view of the FIG. 28 boosted coupled inductor with a magnetic element removed to show an interior of the boosted coupled inductor.

FIGS. 30A and 30B include respective graphs illustrating simulated operation of one embodiment of the FIG. 8 switching power converter.

FIG. 31 is a graph of current versus time illustrating simulated operation of an embodiment of the FIG. 8 switching power converter in response to a change in load.

FIG. 32 is a schematic diagram of an alternate embodiment of the FIG. 8 switching power converter that is optimized for fast transient response instead of being optimized for low ripple current magnitude.

FIG. 33 is a graph of current versus time illustrating simulated operation of an embodiment of the FIG. 32 switching power converter in response to a change in load.

FIG. 34 is a top plan view of the FIG. 9 boosted coupled inductor that is marked-up to illustrate an example of current flow through windings of the boosted coupled inductor.

FIGS. 35A and 35B include respective graphs illustrating an example of operation of one embodiment of the FIG. 8 switching power converter where a turns ratio of a boosted coupled inductor is smaller than optimal.

FIGS. 36A and 36B include respective graphs illustrating an example of operation of one embodiment of the FIG. 8 switching power converter where a turns ratio of a boosted coupled inductor is larger than in the example of FIGS. 35A and 35B.

FIGS. 37A and 36B include respective graphs illustrating an example of operation of one embodiment of the FIG. 8 switching power converter where a turns ratio of a boosted coupled inductor is larger than in the example of FIGS. 36A and 36B.

FIG. 38 is a schematic diagram of an alternate embodiment of the FIG. 8 switching power converter further including a transformer electrically coupled in series with a boost winding.

FIG. 39 is an alternate embodiment of the FIG. 38 switching power converter where a tuning inductor is implemented by leakage inductance of a transformer.

FIG. 40 is a perspective view of one embodiment of the transformer of the FIG. 38 switching power converter.

FIG. 41 is a bottom plan view of the FIG. 40 transformer.

FIG. 42 is a side elevational view of the FIG. 40 transformer.

FIG. 43 is a cross-sectional view of the FIG. 40 transformer taken along line 43A-43A of FIG. 42.

FIG. 44 is a cross-sectional view of the FIG. 40 transformer taken along line 44A-44A of FIG. 41.

FIG. 45 is a front plan view of another embodiment of the transformer of the FIG. 38 switching power converter.

FIG. 46 is a side elevational view of the FIG. 45 transformer.

FIG. 47 is a top plan view of the FIG. 45 transformer.

FIG. 48 is a bottom plan view of the FIG. 45 transformer.

FIG. 49 is a schematic diagram of an alternate embodiment of the FIG. 38 switching power converter including two boosted coupled inductors.

FIG. 50 is a schematic diagram of a switching power converter including transformers and an injection stage, according to an embodiment.

FIGS. 51A and 51B include respective graphs illustrating simulated operation of one embodiment of the FIG. 50 switching power converter.

FIG. 52 is a schematic diagram of a switching power converter including a boosted coupled inductor and an injection stage, according to an embodiment.

FIGS. 53A and 53B include respective graphs illustrating simulated operation of one embodiment of the FIG. 52 switching power converter.

FIG. 54 is a block diagram of an example application of the switching power converters disclosed herein.

### DETAILED DESCRIPTION OF THE EMBODIMENTS

Disclosed herein are switching power converters configured to inject current into a power node of the switching power converter, such as an output power node of the switching power converter. Certain embodiments of the switching power converters are configured such that current injected into the power node at least partially cancels ripple current flowing through power transfer windings, or transformer primary windings, of the switching power converter, thereby promoting low total ripple current magnitude. Certain other embodiments are configured such that current injected into the power node adds to alternating current flowing through power transfer windings, or transformer primary windings, of the switching power converter, thereby promoting fast transient response of the switching power converter. Accordingly, the new switching power converters may achieve higher performance, e.g., lower ripple current magnitude or faster transient response, than conventional switching power converters.

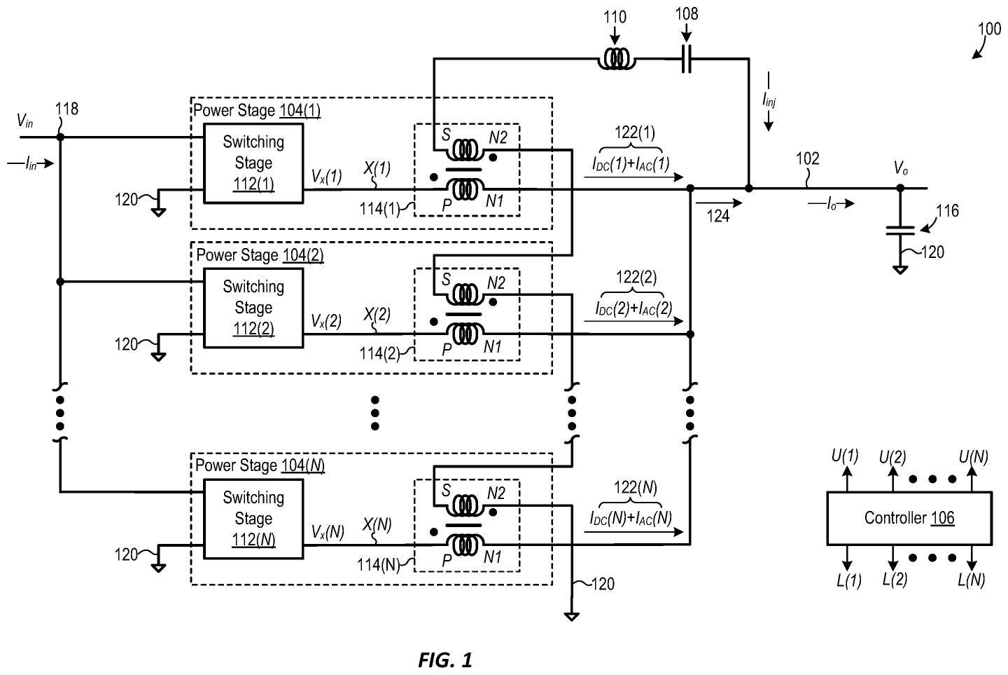

FIG. 1 is a schematic diagram of a multi-phase switching power converter 100, which is one embodiment of the new switching power converters disclosed herein that are configured to inject current into an output power node 102. As discussed below, switching power converter 100 is optimized for minimal total ripple current magnitude at the output. Switching power converter 100 includes N power stages 104, a controller 106, a blocking capacitor 108, and an optional tuning inductor 110, where N is an integer greater than one. In this document, specific instances of an item may be referred to by use of a numeral in parentheses (e.g., power stage 104(1)) while numerals without parentheses refer to any such item (e.g., power stages 104). Each power stage 104 corresponds to a respective phase of switching power converter 100, such that switching power converter 100 is an N-phase switching power converter. In particular, power stage 104(1) corresponds to a first phase of switching power converter 100, power stage 104(2) corresponds to a second phase of switching power converter 100, as so on.

Each power stage 104 includes a switching stage 112 and a power transformer 114, where the switching stage 112 is electrically coupled to a primary winding P of the power transformer 114 at a switching node X. The primary winding P of each power transformer 114 is electrically coupled between the switching node X of its respective power stage 104 and output power node 102. For example, primary winding P of power transformer 114(1) is electrically coupled between switching node X(1) and output power node 102, and primary winding P of power transformer 114(2) is electrically coupled between switching node X(2) and output power node 102. Accordingly, each primary winding P is electrically coupled between the switching stage 112 of its respective power stage 104 and output power node 102. Output power node 102 has a voltage Vₒ, and an output current Iₒ flows to a load (not shown) electrically coupled to output power node 102. Output current Iₒ could have a negative polarity without departing from the scope hereof. One or more capacitors 116 are optionally electrically coupled to output power node 102.

Each switching stage 112 is configured to repeatedly switch the switching node X of its power stage 104 between an input power node 118 and a reference node 120, in response to control signals U and L generated by controller 106. Specifically, switching stage 112(1) is configured to repeatedly switch switching node X(1) between input power node 118 and reference node 120 in response to control signals U(1) and L(1), switching stage 112(2) is configured to repeatedly switch switching node X(2) between input power node 118 and reference node 120 in response to control signals U(2) and L(2), and so on. Input power node 118 is at a voltage Vᵢₙ, and each switching stage 112 accordingly repeatedly switches switching node X of its power stage 104 between voltage Vᵢₙ and zero volts relative to reference node 120. An input current Iᵢₙ flows from an electrical power source (not shown) to switching power converter 100 via input power node 118. Input current Iᵢₙ could have a negative polarity without departing from the scope hereof. A primary winding P of a given power transformer 114(1) in switching power converter 100 is driven “high” when its respective switching node X is at voltage Vᵢₙ, and the primary winding P is driven “low” when its respective switching node X is at zero volts relative to reference node 120. For example, primary winding P of power transformer 114(1) is driven high when switching node X(1) is at voltage Vᵢₙ, and primary winding P of power transformer 114(1) is driven low when switching node X(1) is at zero volts relative to reference node 120. Reference node 120 is depicted as being a ground node, such as an earth ground node or a chassis ground node. It is understood, though, that reference node 120 need not be a ground node, and reference node 120 accordingly could be at a different electrical potential than an earth ground or a chassis ground.

Secondary windings S of power transformers 114, blocking capacitor 108, and tuning inductor 110 are electrically coupled in series between output power node 102 and reference node 120. The respective topological location of each of blocking capacitor 108 and tuning inductor 110 could vary as long as it is electrically coupled in series with secondary windings S. For example, blocking capacitor 108 could be electrically coupled between respective secondary windings S of power transformers 114(1) and 114(2), instead of being electrically coupled between tuning inductor 110 and output power node 102. Additionally, one or more additional elements (not shown) could be electrically coupled in series with blocking capacitor 108, tuning inductor 110, and secondary windings S of power transformers 114 without departing from the scope hereof. While tuning inductor 110 is depicted as being a discrete inductor, tuning inductor 110 could instead be embodied by intrinsic inductance of a circuit including secondary windings S, particularly in applications where tuning inductor 110 need only have a small inductance value. Furthermore, tuning inductor 110 could be omitted, or tuning inductor 110 could be replaced with a plurality of tuning inductors, without departing from the scope hereof. Similarly, blocking capacitor 108 could be replaced with a plurality of blocking capacitors electrically coupled in series and/or in parallel without departing from the scope hereof.

Each primary winding P forms a quantity of turns equal to N1, and each secondary winding S forms a quantity of turns equal to N2. In certain embodiments, a ratio of N1/N2 is equal to N to help minimize magnitude of ripple in output current Iₒ. As discussed above, N is equal to the number of phases of switching power converter 100.

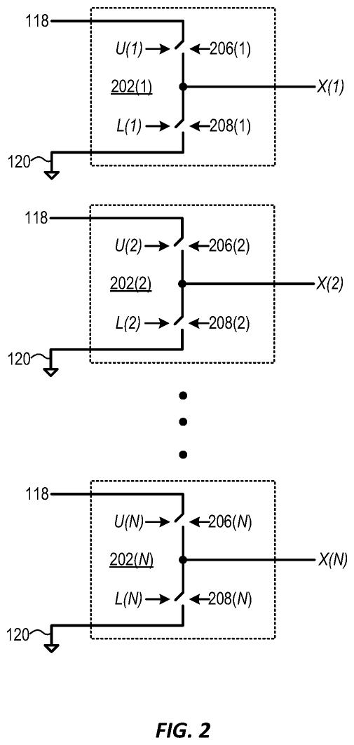

FIG. 2 illustrates one possible implementation of switching stages 112 of switching power converter 100. Specifically, FIG. 2 is a schematic diagram of N switching stages 202, where switching stages 202 are an embodiment of switching stages 112 of FIG. 1. Each switching stage 202 includes an upper switching device 206 and a lower switching device 208. Each upper switching device 206 is electrically coupled between input power node 118 and the switching node X of its respective power stage 104. Each lower switching device 208 is electrically coupled between the switching node X of its respective power stage and reference node 120. For example, upper switching device 206(1) is electrically coupled between input power node 118 and switching node X(1), and lower switching device 208(1) is electrically coupled between switching node X(1) and reference node 120. Each upper switching device 206 switches in response to a respective control signal U from controller 106, and each lower switching device 208 switches in response to a respective control signal L from controller 106. For example, in some embodiments, each upper switching device 206 operates in its on (conductive) state when its respective control signal U is asserted, and the switching device operates in its off (non-conductive state) when its respective control signal U is de-asserted. Similarly, in some embodiments, each lower switching device 208 operates in its on (conductive) state when its respective control signal L is asserted, and the switching device operates in its off (non-conductive state) when its respective control signal L is de-asserted. Each switching device 206 and 208 includes, for example, one or more transistors.

Referring again to FIG. 1, controller 106 is implemented, for example, by analog and/or electronic circuitry. In some embodiments, controller 106 is at least partially implemented by a processor (not shown) executing instructions in the form of software and/or firmware stored in a memory (not shown). Although controller 106 is depicted as being a discrete element for illustrative simplicity, controller 106 could be partially or fully integrated with one or more other elements of switching power converter 100. For example, some subsystems of controller 106 could be incorporated in one or more of switching stages 112. Additionally, FIG. 1 should not be construed to require that there be a separate control bus for each control signal. For example, controller 106 could be implemented by a combination of a central integrated circuit and local control logic integrated in each switching stage 112, with a single control bus running from the central integrated circuit to each switching stage 112. Furthermore, controller 106 may include multiple constituent elements that need not be co-packaged or even disposed at a common location.

Controller 106 is configured to generate control signals U and L to control duty cycle (D) of power stages 104, where duty cycle is a portion of a switching cycle that a primary winding P of a power transformer 114 is driven high, to regulate at least one parameter of switching power converter 100. Controller 106 is configured to vary duty cycle of power stages 104, for example, using a pulse width modulation (PWM) technique and/or a pulse frequency modulation (PFM) technique. Examples of possible regulated parameters include, but are not limited, magnitude of input voltage Vᵢₙ, magnitude of input current Iᵢₙ, magnitude of output voltage Vₒ, and magnitude of output current Iₒ. For example, in some embodiments, controller 106 is configured to generate control signals U and L to regulate magnitude of output voltage Vₒ, and controller 106 accordingly generates control signals U and L during continuous conduction operation of switching power converter 100 such that duty cycle of power stages 104 is equal to a ratio of output voltage magnitude Vₒ over input voltage magnitude Vᵢₙ. For example, if output voltage Vₒ is to be regulated to two volts and input voltage Vᵢₙ is eight volts, controller 106 would generate control signals U and L such that duty cycle of power stages 104 is 0.25, which would result in each primary winding P being driven high for 25 percent of each switching cycle of switching power converter 100. Controller 106 is optionally configured to generate control signals U and L such that power stages 104 switch out-of-phase with each other. For example, in some embodiments, controller 106 is configured to generate control signals U and L such that each power stage 104 switches 360/N degrees out of phase with an adjacent power stage 104 in the phase domain.

Blocking capacitor 108 prevents direct current (DC) shorting of output power node 102 to reference node 120, while allowing alternating current (AC) to flow between secondary windings S and output power node 102. Accordingly, in particular embodiments, blocking capacitor 108 has a sufficiently large capacitance value such that a corner frequency established by blocking capacitor 108 and tuning inductor 110 is significantly lower than a switching frequency of switching power converter 100, to enable injection of current flowing through secondary windings S into output power node 102. Additionally, in certain embodiments, tuning inductor 110 has an inductance of L_{c}, where L_{c}=L_{co}/(N1/N2)². L_{co} is an inductance of tuning inductor 110 that would be selected if a ratio of N1/N2 were one instead of N, such as to achieve a desired performance of switching power converter 100 if the ratio of N1/N2 were one instead of N.

Importantly, switching power converter 100 is configured such that current flowing through secondary windings S of power transformers 114 at least partially cancels ripple current flowing through primary windings P of power transformers 114, at output power node 102 during steady state operation of switching power converter 100. In particular, a respective direct current I_{DC} and a respective alternating current I_{AC} flow through each primary winding P, as illustrated in FIG. 1. Under steady state operating conditions of switching power converter 100, each alternating current I_{AC} is a ripple current generated by switching of switching stages 112. The sum of direct current I_{DC} and alternating current I_{AC} flowing through a given primary winding P may be referred to as current 122 flowing through the primary winding P, as illustrated in FIG. 1. Additionally, a common injection current Iᵢₙⱼ, which is an alternating current, flows through secondary windings S, tuning inductor 110, and blocking capacitor 108, as illustrated in FIG. 1. Injection current Iᵢₙⱼ is also a ripple current under steady state operating conditions of switching power converter 100. Injection current Iᵢₙⱼ is injected into output power node 102. Secondary windings S are electrically coupled to output power node 102 such that injection current Iᵢₙⱼ is at least substantially out-of-phase with respect to alternating currents I_{AC} flowing through primary windings P. While FIG. 1 illustrates one possible polarity of power transformers 114, polarity of power transformers 114 could be different as long as secondary windings S are electrically coupled to output power node 102 in a manner such that injection current Iᵢₙⱼ is at least substantially out-of-phase with respect to alternating currents I_{AC} flowing through primary windings P. Additionally, as discussed above, in particular embodiments, a ratio of N1 to N2 is equal to N, such as that magnitude of injection current Iᵢₙⱼ is substantially equal to a magnitude of a sum of all alternating currents I_{AC} flowing through primary windings P. Accordingly, injection current Iᵢₙⱼ may significantly cancel alternating currents I_{AC} at output power node 102, thereby advantageously helping minimize magnitude of ripple in output current Iₒ.

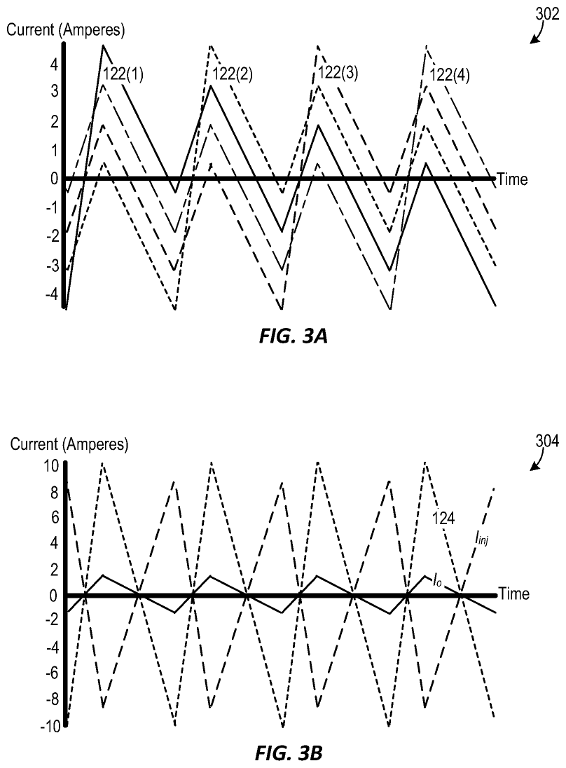

For example, FIGS. 3A and 3B are graphs 302 and 304, respectively, of current versus time of simulated operation of one embodiment of switching power converter 100 where N=4, switching frequency is one Megahertz (MHz), magnetizing inductance (Lₘ) of each power transformer 114 is 150 nanohenrys (nH), N1/N2=4, Vᵢₙ=12 volts, Vₒ=1 volt, and inductance (L_{c}) of tuning inductor 130 is 7.5 nH. Graphs 302 and 304 have a common time base. Graph 302 includes curves representing each of currents 122(1), 122(2), 122(3) and 122(4) flowing through primary winding P of power transformers 114(1), 114(2), 114(3), and 114(4), respectively. Graph 304 includes curves representing (a) total current 124 flowing through all primary windings P (see FIG. 1) under a zero load condition for switching power converter 100, (b) injection current Iᵢₙⱼ injected into output power node 102, and (c) output current Iₒ under a zero load condition for switching power converter 100. If load is applied to the output power node 102 of switching power converter 100, then total current 124 and output current Iₒ will have a non-zero DC current added to the waveforms in FIG. 3A, while phase currents 122 in FIG. 3A will also have a corresponding DC level added to the waveforms. Total current 124 has a peak-to-peak ripple current magnitude of almost 20 amperes, as illustrated in FIG. 3B. If injection current Iᵢₙⱼ were not injected into output power node 102, output current Iₒ would be the same as total current 124, and output current Iₒ would therefore also have a peak-to-peak ripple current magnitude of almost 20 amperes. However, injection current Iᵢₙⱼ is out-of-phase with respect to total current 124, and peak-to-peak magnitude of injection current Iᵢₙⱼ is almost as large as the peak-to-peak magnitude of total current 124. Therefore, injection current Iᵢₙⱼ substantially cancels ripple current flowing through primary windings P, at output power node 102. Consequently, output current Iₒᵤₜ has a relatively small ripple current magnitude of only around 2.9 amperes. As such, injecting injection current Iᵢₙⱼ into output power node 102 substantially reduces magnitude of ripple in output current Iₒ.

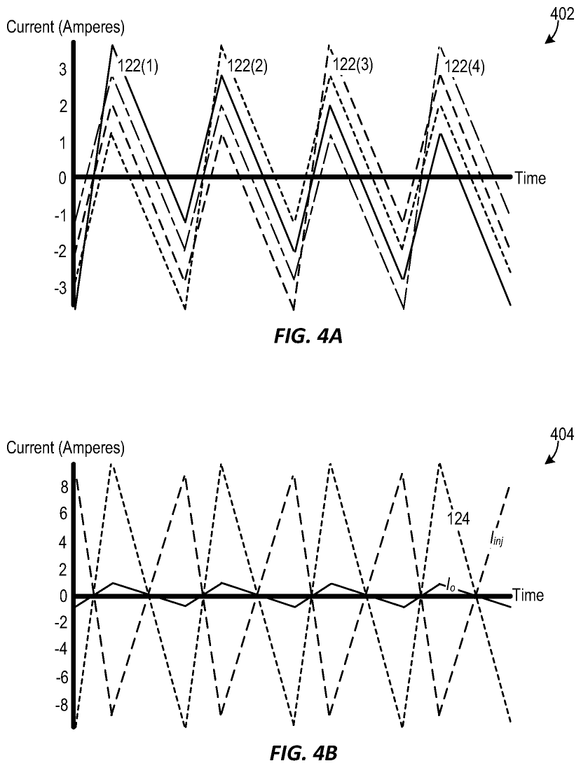

As another example, FIGS. 4A and 4B are graphs 402 and 404, respectively, of current versus time of simulated operation of one embodiment of switching power converter 100 where N=4, switching frequency is one MHz, Lₘ of each power transformer 114 is 250 nH (instead of 150 nH as in the simulation of FIGS. 3A and 3B), N1/N2=4, Vᵢₙ=12 volts, Vₒ=1 volt, and L_{c} of tuning inductor 130 is 7.5 nH. Graphs 402 and 404 have a common time base. Graph 402 includes curves representing each of currents 122(1), 122(2), 122(3) and 122(4) flowing through primary winding P of power transformers 114(1), 114(2), 114(3), and 114(4), respectively. Graph 404 includes curves representing (a) total current 124 flowing through all primary windings P, (b) injection current Iᵢₙⱼ injected into output power node 102, and (c) output current Iₒ. Total current 124 has a peak-to-peak ripple current magnitude of about 18 amperes, as illustrated in FIG. 4B. However, injection current Iᵢₙⱼ substantially cancels ripple current flowing through primary windings P, at output power node 102. Consequently, output current Iₒᵤₜ has a relatively small ripple current magnitude of only around 1.65 amperes. As evident when comparing the simulations of FIGS. 3A and 3B to the simulations of FIGS. 4A and 4B, increasing magnetizing inductance of power transformers 114 may reduce magnitude of ripple in output current Iₒ.

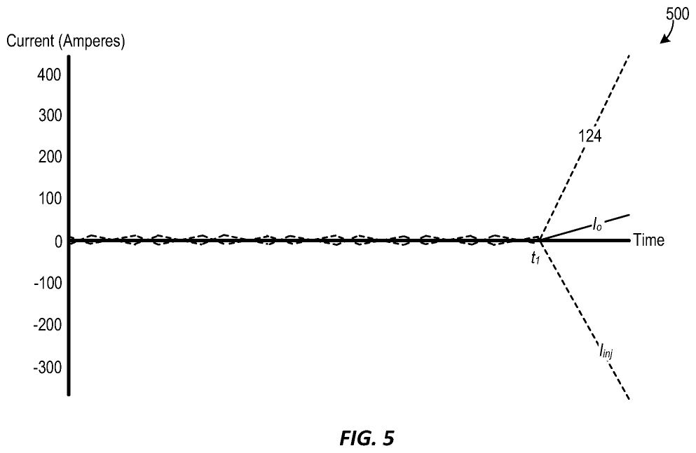

While injection of injection current Iᵢₙⱼ into output power node 102 reduces magnitude of ripple in output current Iₒ, such injection also degrades transient response of switching power converter 100. For example, FIG. 5 is a graph 500 of current versus time illustrating simulated operation of an embodiment of switching power converter 100 in response to a change in load. Prior to time t₁, a load powered by switching power converter 100 is zero, and a DC component of output current Iₒ is therefore zero. At time t₁, though, the load powered by switching power converter 100 rapidly increases, and total current 124 therefore ramps up. However, injection current Iᵢₙⱼ injected into output power node 102 ramps up in the opposite direction of total current 124, and the injected current therefore slows the rise of output current Iₒ in response to the load increase, thereby degrading the transient response of switching power converter 100.

Switching power converter 100 can be modified so that injection current Iᵢₙⱼ adds to alternating currents I_{AC} in output power node 102, instead of subtracting from (canceling) alternating currents I_{AC}, thereby promoting fast transient response of the switching power converter at the expensive of larger magnitude of ripple of output current Iₒ. For example, FIG. 6 is a schematic diagram of switching power converter 600, which is an alternate embodiment of switching power converter 100 that is optimized for fast transient response instead of for low ripple current magnitude. Switching power converter 600 differs from switching power converter 100 only in the manner that secondary windings S are electrically coupled to output power node 102. In particular, in switching power converter 100 (FIG. 1), secondary windings S are electrically coupled in series between output power node 102 and reference node 120 such that injection current Iᵢₙⱼ is out of phase with respect to alternating currents I_{AC} flowing through primary windings P. In switching power converter 600 (FIG. 6), in contrast, secondary windings S are electrically coupled in series between output power node 102 and reference node 120 such that injection current Iᵢₙⱼ adds to alternating currents I_{A}C flowing through primary windings P, thereby promoting fast transient response of switching power converter 600 with the potential drawback of larger magnitude of ripple in output current Iₒ. It should be noted, though, that magnitude of ripple current decreases with increasing number of phases of switching power converter 600. Therefore, in embodiments of switching power converter 600 where Nis large, increase in magnitude of ripple in output current Iₒ current caused by injecting injection current Iᵢₙⱼ into output power node 102 may be immaterial because ripple current magnitude is very small due to N being large. While FIG. 6 illustrates one possible polarity of power transformers 114, polarity of power transformers 114 could be different as long as secondary windings S are electrically coupled to output power node 102 in a manner such that injection current Iᵢₙⱼ adds to alternating currents I_{AC} flowing through primary windings P.

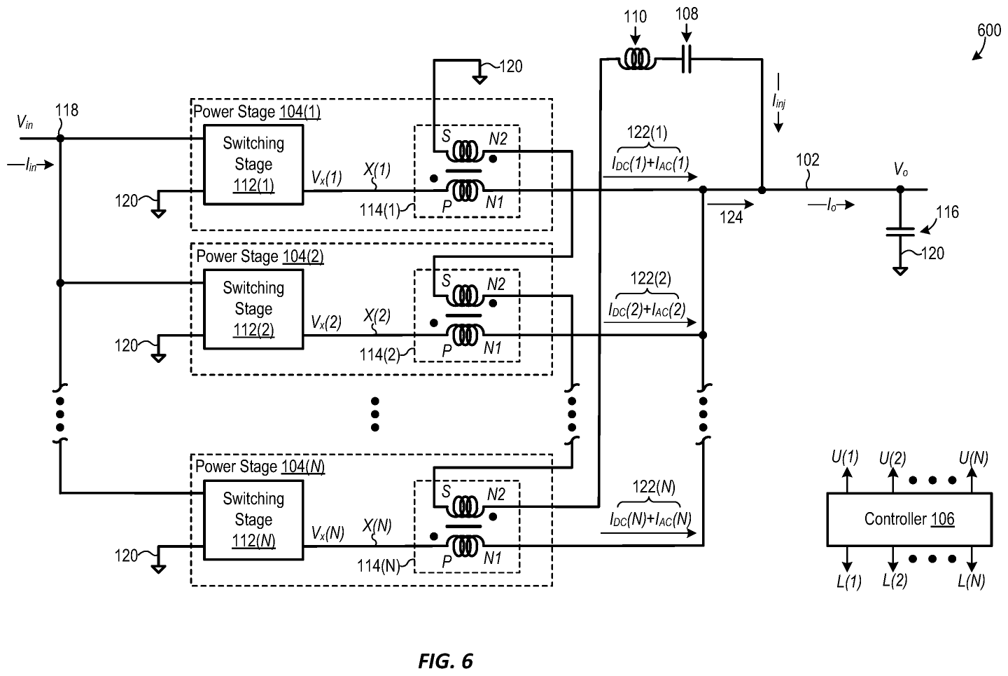

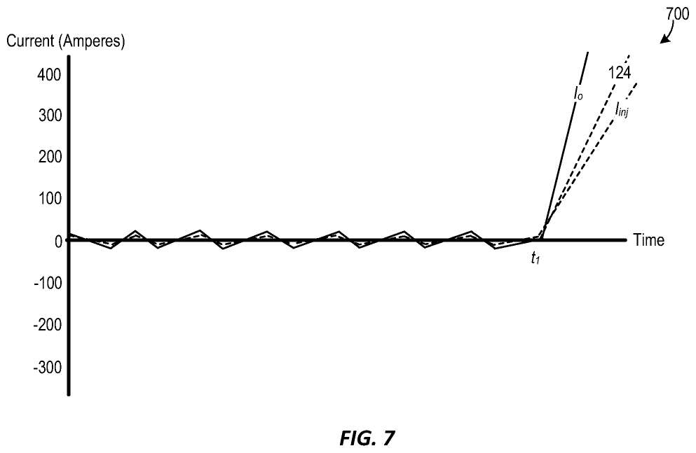

FIG. 7 is a graph 700 of current versus time illustrating simulated operation of an embodiment of switching power converter 600 in response to a change in load. Prior to time t₁, a load powered by switching power converter 600 is zero, and magnitude of output current Iₒ is therefore zero (neglecting ripple current). At time t₁, though, the load powered by switching power converter 600 rapidly increases, and total current 124 therefore ramps up. Additionally, injection current Iᵢₙⱼ injected into output power node 102 ramps up in the same direction as total current 124, and the injected current adds to total current 124 and increases the rate of rise of output current Iₒ in response to the load increase, thereby improving the transient response of switching power converter 100. However, the fact that in steady state injection current Iᵢₙⱼ adds to alternating currents I_{AC} flowing through primary windings P increases magnitude of ripple in output current Iₒ.

FIG. 8 is a schematic diagram of a multi-phase switching power converter 800, which is another embodiment of the new switching power converters disclosed herein configured to inject current into an output power node. As discussed below, switching power converter 800 is optimized for minimal ripple current magnitude. Switching power converter 800 includes N power stages 804, a controller 806, a blocking capacitor 808, an optional tuning inductor 810, and a boost winding 811, where N is an integer greater than one. Each power stage 804 corresponds to a respective phase of switching power converter 800, such that switching power converter 800 is an N-phase switching power converter. In particular, power stage 804(1) corresponds to a first phase of switching power converter 800, power stage 804(2) corresponds to a second phase of switching power converter 800, and so on.

Each power stage 804 includes a switching stage 812 electrically coupled to a power transfer winding 814 at a switching node X. Each power transfer winding 814 is electrically coupled between the switching node X of its respective power stage 804 and output power node 802. For example, power transfer winding 814(1) is electrically coupled between switching node X(1) and output power node 802, and power transfer winding 814(2) is electrically coupled between switching node X(2) and output power node 802. Output power node 802 has a voltage Vₒ, and an output current Iₒ flows to a load (not shown) electrically coupled to output power node 802. Output current Iₒ could have a negative polarity without departing from the scope hereof. One or more capacitors 816 are optionally electrically coupled to output power node 802.

Each switching stage 812 is configured to repeatedly switch the switching node X of its power stage 804 between an input power node 818 and a reference node 820, in response to control signals U and L generated by controller 806. Specifically, switching stage 812(1) is configured to repeatedly switch node X(1) between input power node 818 and reference node 820 in response to control signals U(1) and L(1), switching stage 812(2) is configured to repeatedly switch node X(2) between input power node 818 and reference node 820 in response to control signals U(2) and L(2), and so on. Input power node 818 is at a voltage Vᵢₙ, and each switching stage 812 accordingly repeatedly switches node X of its power stage 804 between voltage Vᵢₙ and zero volts relative to reference node 820. Reference node 820 is depicted as being a ground node, such as an earth ground node or a chassis ground node. It is understood, though, that reference node 820 need not be a ground node, and reference node 820 accordingly could be at a different electrical potential than an earth ground or a chassis ground.

An input current Iᵢₙ flows from an electrical power source (not shown) to switching power converter 800 via input power node 818. Input current Iᵢₙ could have a negative polarity without departing from the scope hereof. A given power transfer winding 814 in switching power converter 800 is driven “high” when its respective switching node X is at voltage Vᵢₙ, and the power transfer winding 814 is driven “low” when its respective switching node X is at zero volts relative to reference node 820. For example, power transfer winding 814(1) is driven high when switching node X(1) is at voltage Vᵢₙ, and power transfer winding 814(1) is driven low when switching node X(1) is at zero volts relative to reference node 820. In certain embodiments, switching stages 812 are similar to switching stages 202 of FIG. 2.

Boost winding 811, blocking capacitor 808, and tuning inductor 810 are electrically coupled in series between output power node 802 and reference node 820. The respective topological location of each of blocking capacitor 808 and tuning inductor 810 could vary as long as it is electrically coupled in series with boost winding 811. For example, blocking capacitor 808 could be electrically coupled between boost winding 811 and reference node 820, instead of being electrically coupled between tuning inductor 810 and output power node 802. Additionally, one or more additional elements (not shown) could be electrically coupled in series with blocking capacitor 808, tuning inductor 810, and boost winding 811 without departing from the scope hereof. While tuning inductor 810 is depicted as being a discrete inductor, tuning inductor 810 could instead be embodied by intrinsic inductance of a circuit including boost winding 811, particularly in applications where tuning inductor 810 need only have a small inductance value. Furthermore, tuning inductor 810 could be omitted, or tuning inductor 810 could be replaced with a plurality of tuning inductors, without departing from the scope hereof. Similarly, blocking capacitor 808 could be replaced with a plurality of blocking capacitors electrically coupled in series and/or in parallel without departing from the scope hereof.

Each power transfer winding 814 forms a quantity of turns equal to N1, and boost winding 811 forms a quantity of turns equal to N2. In certain embodiments, a ratio of N1/N2 is equal to N to help minimize magnitude of ripple in output current Iₒ. As discussed above, N is equal to the number of phases of switching power converter 800.

Power transfer windings 814 are magnetically coupled by a magnetic core 813. Boost winding 811 is magnetically coupled to a leakage component (not illustrated in FIG. 8) of each power transfer winding 814 by magnetic core 813. In particular, boost winding 811 is configured such that it forms at least one turn around a respective total magnetic flux path of each power transfer winding 814. Importantly, boost winding 811 is additionally configured such that net mutual magnetic flux within the turns of the boost winding is essentially zero during steady state operation of switching power converter 800. Equivalently, boost winding 811 can be configured such that it forms at least one turn around only a respective leakage magnetic flux path of each power transfer winding 814. Such configuration of boost winding 811 advantageously helps minimize risk of a magnetic saturation from mutual magnetic flux within a magnetic flux path of boost winding 811 while enabling injection of injection current into output power node 802. In this document, a winding forming a turn around an element need not completely surround the element. For example, a winding forming a turn around a leg of a magnetic core need not completely surround the leg. As another example, a winding forming a turn around a magnetic flux path need not completely surround the magnetic flux path.

Power transfer windings 814, boost winding 811, and magnetic core 813 are part of a boosted coupled inductor 815. Magnetic core 813 is formed, for example, of a ferrite magnetic material, a composite magnetic material, or an iron powder magnetic material. However, magnetic core 813 could alternately be an “air core,” or in other words, magnetic core 813 could be implemented by placing windings 814 and 811, or breaking these windings in sections and placing these sections in pairs in sufficient proximity, to achieve magnetic coupling without use of a tangible magnetic coupling structure. Boost winding 811 is drawn with a heavier line weight than power transfer windings 814 to help a viewer distinguish boost winding 811 from power transfer windings 814. This difference in line weight should not be construed to imply that boost winding 811 is necessarily formed of a thicker conductor material than power transfer windings 814. Boost winding 811 could actually be implemented with a smaller amount of conductor material because it carries only alternating current ripple and does not carry any load current.

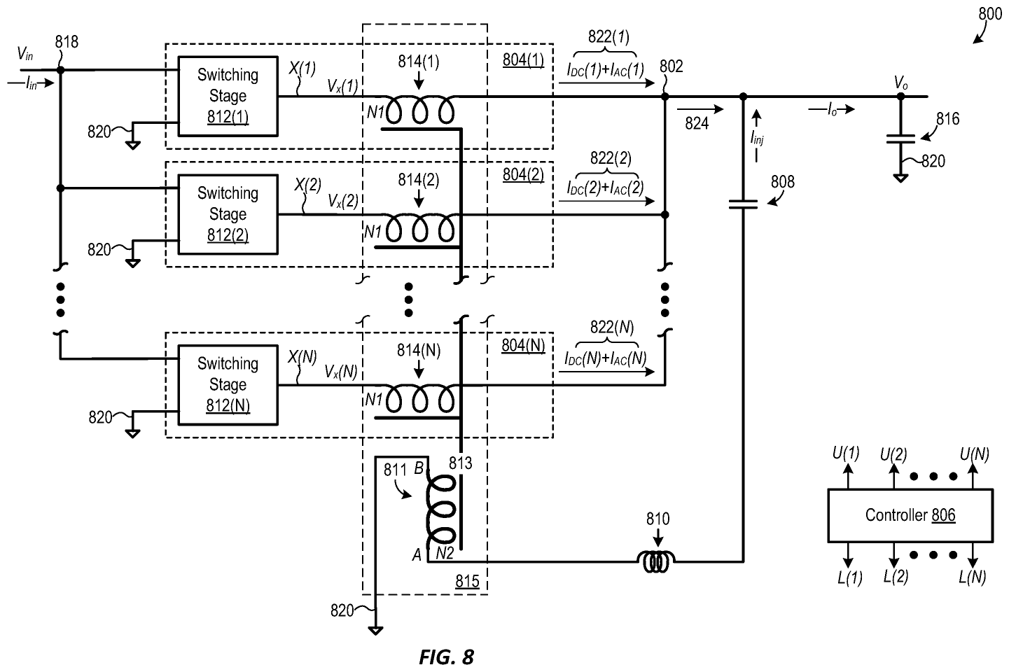

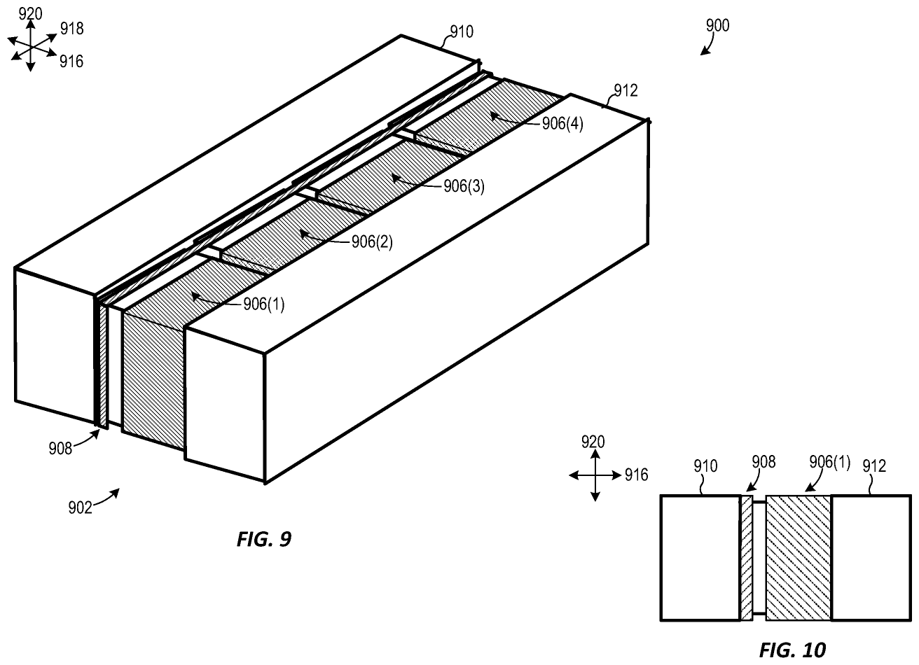

Discussed below with respect to FIGS. 9-29 are several example embodiments of boosted coupled inductor 815. It is understood, however, that boosted coupled inductor 815 is not limited to these example embodiments.

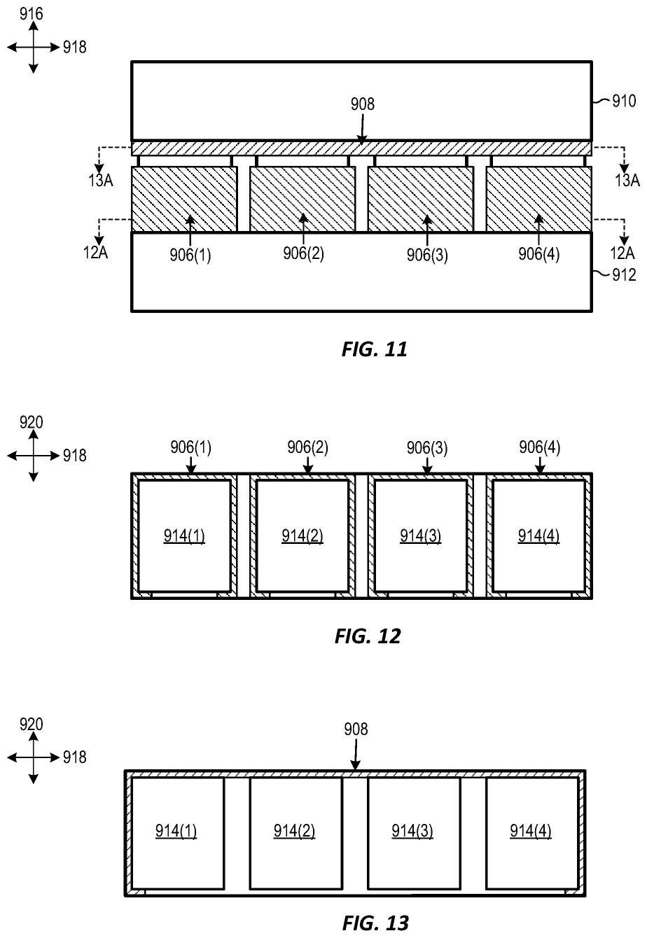

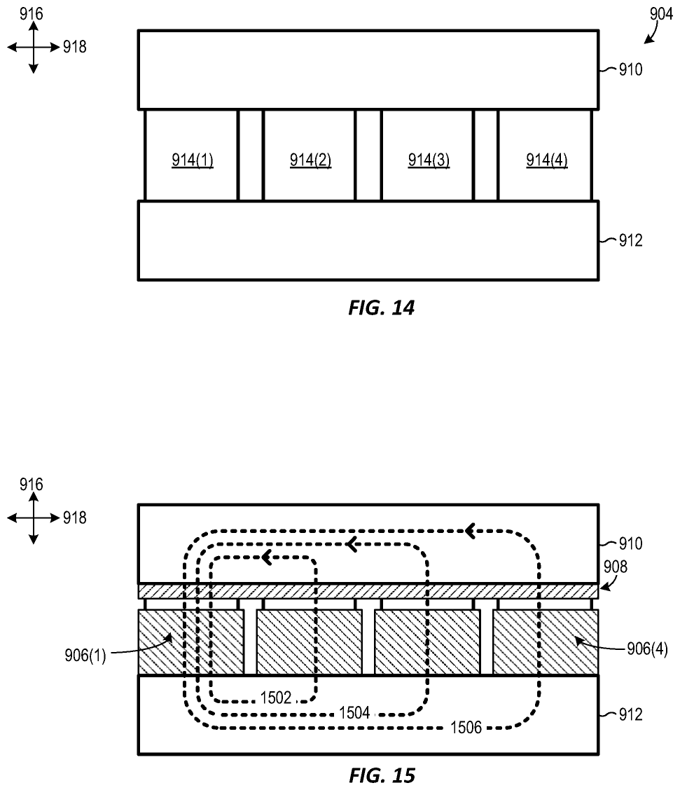

FIG. 9 is a perspective view of a boosted coupled inductor 900, which is one possible embodiment of boosted coupled inductor 815 where N is equal to 4. FIG. 10 is an elevational view of a side 902 of boosted coupled inductor 900, FIG. 11 is a top plan view of boosted coupled inductor 900, FIG. 12 is a cross-sectional view of boosted coupled inductor 900 taken along line 12A-12A of FIG. 11, and FIG. 13 is a cross-sectional view of boosted coupled inductor 900 taken along line 13A-13A of FIG. 11. FIG. 14 is a top plan view of boosted coupled inductor 900 with windings omitted, to further show a magnetic core of the boosted coupled inductor.

Boosted coupled inductor 900 includes a magnetic core 904 (see FIG. 14), a plurality of power transfer windings 906, and a boost winding 908. Power transfer windings 906 are embodiments of power transfer windings 814, and boost winding 908 is an embodiment of boost winding 811. Magnetic core 904 is an embodiment of magnetic core 813. Magnetic core 904 is formed, for example, of a ferrite magnetic material or a powdered iron magnetic material. Magnetic core 904 includes a first rail 910, a second rail 912, and a plurality of legs 914. Although magnetic core 904 is illustrated as including four legs 914, the number of legs 914 of magnetic core 904 will vary with the number of phases supported by boosted coupled inductor 900. For example, in embodiments of boosted coupled inductor 900 intended for use with three phases, i.e., with N=3, boosted coupled inductor 900 will have three legs 914 instead of four legs 914. First rail 910 and second rail 912 are separated from each other in a direction 916, and legs 914 are disposed between first rail 910 and second rail 912 in direction 916. Legs 914 are separated from each other in a direction 918, where direction 918 is orthogonal to direction 916. FIGS. 9, 10, 12, and 13 further show a third direction 920 which is orthogonal to each of directions 916 and 918. In some embodiments, legs 914 join first and second rails 910 and 912 in direction 916, and in some other embodiments, one or more of legs 914 is separated from first rail 910 and/or second rail 912 by a respective gap (not shown), such as to help prevent saturation of magnetic core 904. Each leg 914 optionally also forms a respective gap (not shown) along direction 918, such that the leg is broken into two or more portions separated from each other in direction 916 by the gap.

A respective power transfer winding 906 is wound at least partially around each leg 914, and boost winding 908 is wound at least partially around all legs 914, such that boost winding 908 forms a common turn around all legs 914. Accordingly, boost winding 908 is strongly magnetically coupled to each power transfer winding 906. Boost winding 908 is electrically isolated from power transfer windings 906. Although each power transfer winding 906 and boost winding 908 is depicted as being a single-turn winding formed of electrically conductive foil, such as copper foil, the configurations of power transfer windings 906 and boost winding 908 may vary. For example, one or more of these windings may form a plurality of turns, and/or one or more of these windings may be formed of wire instead of electrically conductive foil. As another example, a ratio of a quantity N1 of turns formed by each power transfer winding 906 to a quantity N2 of turns formed by boost winding 908 may be a function of number of phases in a switching power converter including boosted coupled inductor 900, e.g., N1/N2=N.

FIG. 15 is a top plan view that is similar to FIG. 11 and is marked-up to symbolically show several mutual magnetic flux paths in boosted coupled inductor 900. Lines 1502, 1504, and 1506 represent mutual magnetic flux flowing from power transfer winding 906(1) to power transfer windings 906(2), 906(3), and 906(4), respectively. While not shown in FIG. 15, there are additional mutual magnetic flux paths between other power transfer winding 906 instances that pass through the turn formed by boost winding 908. As can be appreciated from FIG. 15, although mutual magnetic flux from each power transfer winding 906 flows through the turn of boost winding 908, net mutual magnetic flux flowing through boost winding 908 may be zero in some applications, e.g., mutual magnetic flux from power transfer winding 906(1) may cancel itself because all return paths of such flux are also included under the boost winding 908, leading to the net zero flux. The same is true for the mutual magnetic flux from any other power transfer windings 906 in boost winding 908, such that boost winding 908 “sees” zero mutual magnetic flux.

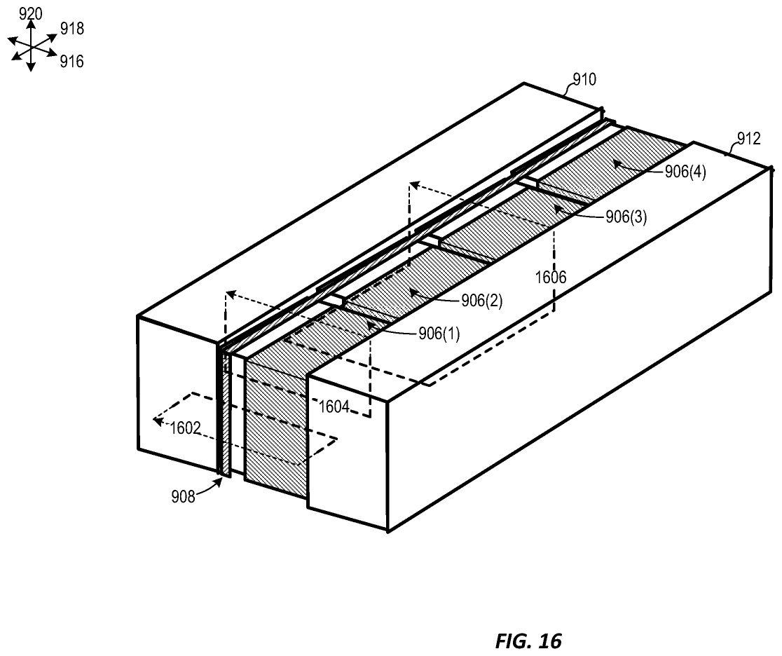

Additionally, leakage magnetic flux generally flows through the turn of boost winding 908, such that boost winding 908 is strongly magnetically coupled to leakage magnetic flux associated with power transfer windings 906. For example, FIG. 16 is a perspective view that is similar to FIG. 9 and is marked-up to symbolically show a few example leakage magnetic flux paths in boosted coupled inductor 900. In particular, FIG. 16 illustrates three example leakage magnetic flux paths 1602, 1604, and 1606 associated with power transfer winding 906(1). It should be noted that all shown leakage magnetic flux paths 1602, 1604, and 1606 pass through the turn formed by boost winding 908. The thick dashed lines of FIG. 16 represent leakage magnetic flux flowing internal to magnetic core 904, while the thin dashed lines of FIG. 16 represent leakage magnetic flux flowing external to magnetic core 904. Additionally, while not shown in FIG. 16, there are additional leakage magnetic flux paths for power transfer winding 906(1), as well as leakage magnetic flux paths for power transfer windings 906(2)-906(4), which pass through the turn formed by boost winding 908. Accordingly, boost winding 908 forms a turn around respective leakage magnetic flux paths for each power transfer winding 906. The fact that boost winding 908 is within mutual magnetic flux paths helps maximize leakage magnetic flux coupling to boost winding 908, by reducing potential for leakage magnetic flux to escape from magnetic core 904 before coupling to boost winding 908. Nevertheless, some leakage magnetic flux associated with power transfer windings 906(1)-906(4) does not pass through the turn formed by boost winding 908.

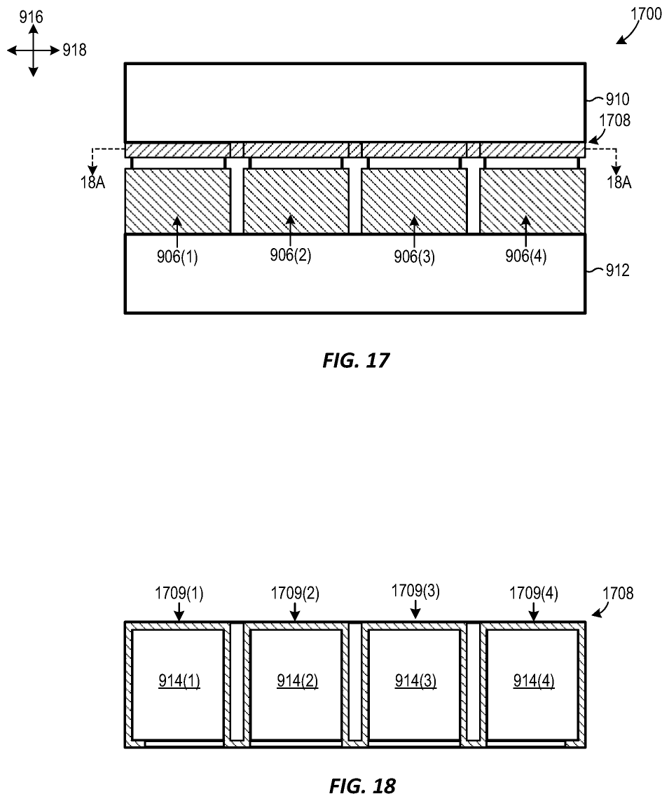

Boost winding 908 forms a common turn around all legs 914, such as illustrated in FIG. 13. However, boost winding 908 could be modified to form a respective turn around each leg 914, with all of the turns electrically coupled in series. For example, FIG. 17 is a top plan view of a boosted coupled inductor 1700, and FIG. 18 is a cross-sectional view of boosted coupled inductor 1700 taken along line 18A-18A of FIG. 17. Boosted coupled inductor 1700 is an alternate embodiment of boosted coupled inductor 900 where boost winding 908 is replaced with a boost winding 1708 forming a respective turn 1709 around each leg 914. Turns 1709 are electrically coupled in series. Accordingly, boost winding 1708 has similar electrical properties to boost winding 908. For example, boost winding 1708 is strongly magnetically coupled to leakage elements of power transfer windings 906, and boosted coupled inductor 1700 is capable of being operated such that net mutual magnetic flux flowing through boost winding 1708 is essentially zero.

Boosted coupled inductors 900 and 1700 are configured to minimize leakage inductance of power transfer windings 906, as large leakage inductance is not required to achieve small leakage current magnitude in switching power converter 800. Additionally, small leakage inductance values promote good transient response of switching power converter 800. Nevertheless, should larger leakage inductance be desired or required, boosted coupled inductors 900 and 1700 could be modified to include features for increasing leakage inductance, such as one or more magnetic elements configured to provide a leakage magnetic flux path between first rail 910 and second rail 912.

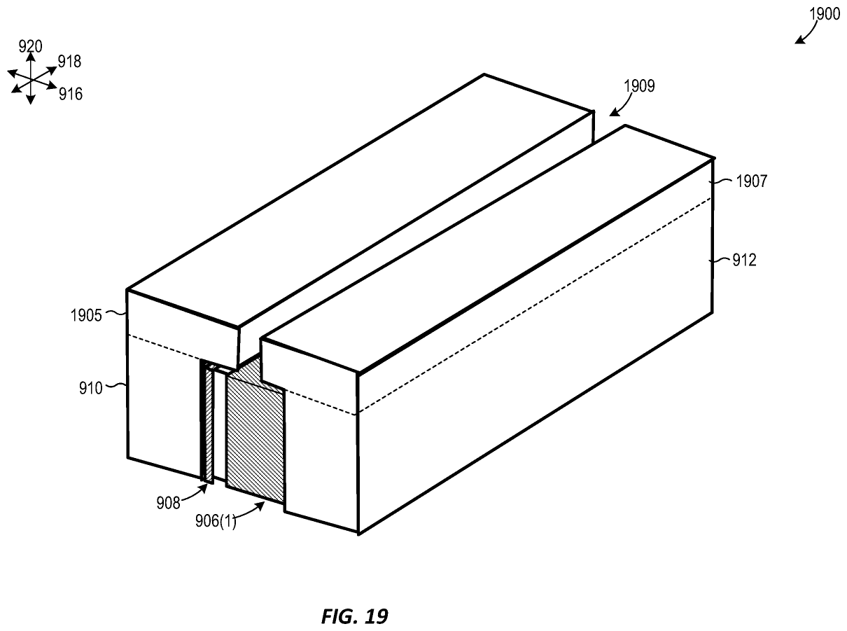

For example, FIG. 19 is a perspective view of a boosted coupled inductor 1900, which is an alternate embodiment of boosted coupled inductor 900 further including leakage elements 1905 and 1907. Leakage element 1905 is joined to rail 910, and leakage element 1907 is joined to rail 912. Leakage elements 1905 and 1907 are formed of a magnetic material, such as a ferrite magnetic material or a powdered iron magnetic material. Leakage elements 1905 and 1907 extend towards each other in direction 916 to provide a relatively low reluctance path for leakage magnetic flux to flow between rails 910 and 912. Leakage elements 1905 and 1907 are optionally separated by a gap 1909 in direction 916 where gap 1909 is filled with, for example, air, paper, plastic, adhesive, and/or a magnetic material having a lower magnetic permeability that magnetic material forming leakage elements 1905 and 1907. Gap 909 can be split into two or more smaller gaps to decrease the fringing flux. The dotted lines delineating leakage elements 1905 and 1907 from rails 910 and 912, respectively, are to assist a viewer in distinguishing features of boosted coupled inductor 1900, and these lines do not necessarily represent discontinuities in boosted coupled inductor 1900.

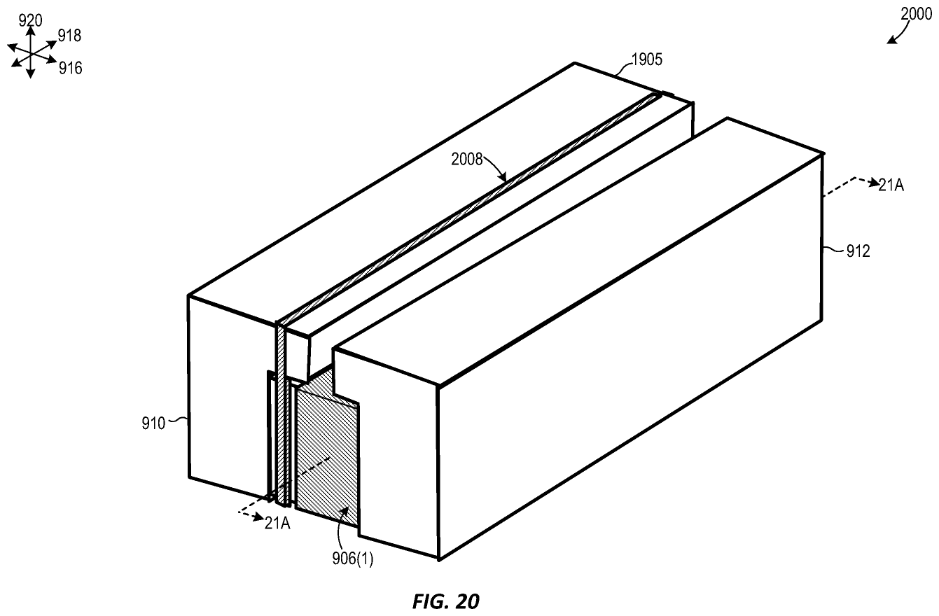

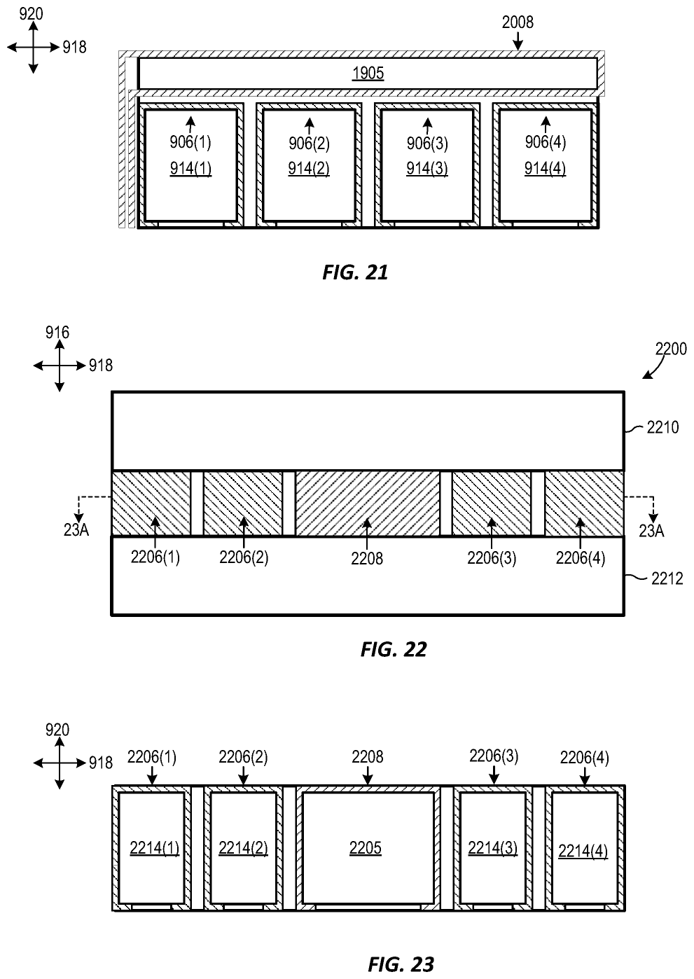

Boosted coupled inductor 1900 could be modified so that its boost winding is wound around one or more leakage elements 1905 and 1907, instead of being wound around legs 914. For example, FIG. 20 is a perspective view of a boosted coupled inductor 1900, and FIG. 21 is a cross-sectional view of boosted coupled inductor 1900 taken along a line 21A-21A of FIG. 20. Boosted coupled inductor 2000 is an alternate embodiment of boosted coupled inductor 1900 where boost winding 908 is replaced with a boost winding 2008, where boost winding 2008 is another embodiment of boost winding 811. Boost winding 2008 forms a turn around leakage element 1905, which results in boost winding 2008 forming a turn around leakage magnetic flux paths of each power transfer winding 906. Additionally, boost winding 2008 is outside of mutual magnetic flux paths of power transfer windings 906. Consequently, mutual magnetic flux does not flow through the turn of boost winding 2008, and net mutual magnetic flux flowing though boost winding 2008 is accordingly zero.

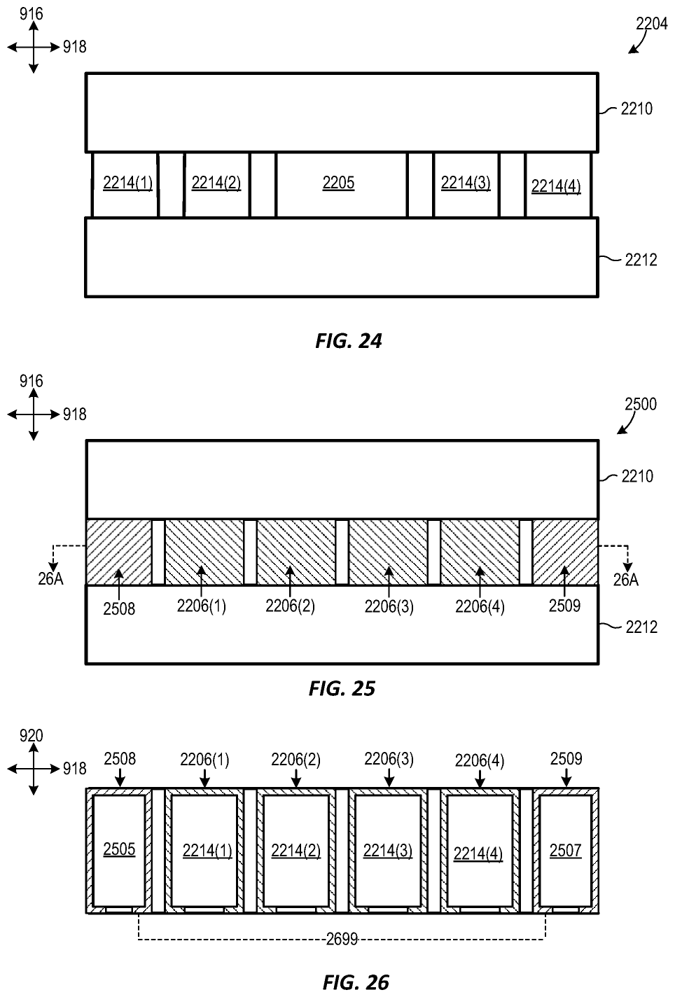

Boosted coupled inductor 2000 could be modified to have a different leakage element configuration. For example, FIG. 22 is a top plan view of a boosted coupled inductor 2200, and FIG. 23 is a cross-sectional view of boosted coupled inductor 2200 taken along line 23A-23A of FIG. 22, where boosted coupled inductor 2200 is an alternate embodiment of boosted coupled inductor 2000 with a different leakage element configuration. FIG. 24 is a top plan view of boosted coupled inductor 2200 with windings omitted, to further show a magnetic core of the boosted coupled inductor.

Boosted coupled inductor 2200 includes a magnetic core 2204 (see FIG. 24), a plurality of power transfer windings 2206, and a boost winding 2208. Power transfer windings 2206 are embodiments of power transfer windings 814, and boost winding 2208 is an embodiment of boost winding 811. Magnetic core 2204 is formed, for example, of a ferrite magnetic material or a powdered iron magnetic material. Magnetic core 2204 includes a first rail 2210, a second rail 2212, and a plurality of legs 2214. Although magnetic core 2204 is illustrated as including four legs 2214, the number of legs 2214 of magnetic core 2204 will vary with the number of phases supported by boosted coupled inductor 2200. First rail 2210 and second rail 2212 are separated from each other in direction 916, and legs 2214 are disposed between first rail 2210 and second rail 2212 in direction 916. Legs 2214 are separated from each other in direction 918. In some embodiments, legs 2214 join first and second rails 2210 and 2212 in direction 916, and in some other embodiments, legs 2214 are separated from first rail 2210 and/or second rail 2212 by a respective gap (not shown), such as to help prevent saturation of magnetic core 2204. Each leg 2214 optionally also forms a respective gap (not shown) along direction 918, such that the leg is broken into two portions separated from each other in direction 916 by the gap.

Magnetic core 2204 further includes a leakage element 2205 disposed between first rail 2210 and second rail 2212 in direction 916. In some embodiments, leakage element 2205 is separated from first rail 2210 and/or second rail 2212 by a respective gap (not shown). Leakage element 2205 optionally also forms a gap (not shown) along direction 916, such that the leakage element is broken into two or more portions separated from each other in direction 916 by the gap. While FIGS. 22-24 depict leakage element 2205 being disposed between legs 2214(2) and 2214(3) in direction 918 so that the leakage element is centrally located with respect to legs 2214, location of leakage element 2205 could vary as long as it is disposed between first rail 2210 and second rail 2212 in direction 916. For example, leakage element 2205 could alternately be disposed between legs 2214(1) and 2214(2) in direction 918. While not required, it is anticipated that leakage element 2205 will typically have a larger cross-sectional area (in directions 918 and 920) than each leg 2214, such as illustrated in FIG. 23, because leakage element 2205 sees leakage magnetic flux from each leg 2214. Additionally, while not required, it is anticipated that a gap in leakage element 2205, when present, will be larger than gaps in the legs 2214, when present, so that the leakage inductance value will be lower than the magnetizing inductance values of power transfer windings 2206, which also promotes a higher saturation current for the leakage.

A respective power transfer winding 2206 is wound at least partially around each leg 2214. Additionally, boost winding 2208 is wound at least partially around leakage element 2205, which results in boost winding 2208 forming a turn around leakage magnetic flux paths of each power transfer winding 2206. Additionally, boost winding 2208 is outside of mutual magnetic flux paths of power transfer windings 2206. Consequently, mutual magnetic flux does not flow through the turn of boost winding 2208, and net mutual magnetic flux flowing though boost winding 2208 is accordingly zero. Boost winding 2208 is electrically isolated from power transfer windings 2206. Although each power transfer winding 2206 and boost winding 2208 is depicted as being a single-turn winding formed of electrically conductive foil, such as copper foil, the configurations of power transfer windings 2206 and boost winding 2208 may vary. For example, one or more of these windings may form a plurality of turns, and/or one or more of these windings may be formed of wire instead of electrically conductive foil.

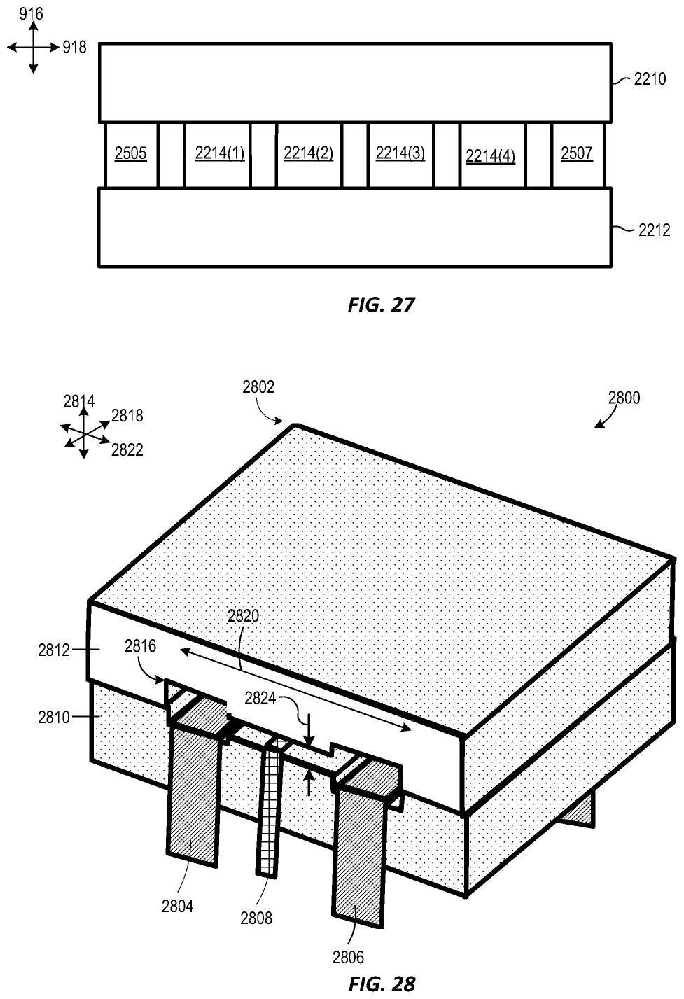

Leakage element 2205 and boost winding 2208 could be replaced with two or more leakage elements and boost windings, respectively. For example, FIG. 25 is a top plan view of a boosted coupled inductor 2500, and FIG. 26 is a cross-sectional view of boosted coupled inductor 2500 taken along line 26A-26A of FIG. 25. Boosted coupled inductor 2500 is an alternate embodiment of boosted coupled inductor 2200 (a) where leakage element 2205 is replaced with two leakage elements 2505 and 2507 and (b) boost winding 2208 is replaced with two boost windings 2508 and 2509, where boost windings 2508 and 2509 are collectively an embodiment of boost winding 811. FIG. 27 is a top plan view of boosted coupled inductor 2500 with windings omitted, to further show the magnetic core of the boosted coupled inductor.

Each leakage element 2505 and 2507 is disposed between first rail 2210 and second rail 2212 in direction 916, and leakage elements 2205 and 2207 are separated from each other in direction 918. While FIGS. 25-27 depict leakage elements 2505 and 2507 being disposed at opposing ends of boosted coupled inductor 2500, the location of leakage elements 2505 and 2507 may vary, as long as each leakage element is disposed between first rail 2210 and second rail 2212 in direction 916. Leakage elements 2505 and 2507 optionally also form a gap (not shown), such that the leakage element is broken into two or more portions separated from each other in direction 916 by the gap. Boost winding 2508 is wound around leakage element 2505, and boost winding 2509 is wound around leakage element 2507. As such, each boost winding 2508 and 2509 forms a respective turn around leakage magnetic flux paths of each power transfer winding 2206. Additionally, each boost winding 2508 and 2509 is outside of mutual magnetic flux paths of power transfer windings 2206. Consequently, mutual magnetic flux does not flow through the respective turns of boost windings 2508 and 2509, and net mutual magnetic flux flowing through each boost winding 2508 and 2509 is accordingly zero.

Boost windings 2508 and 2509 will typically be electrically coupled in series, as symbolically shown by a dashed line 2699 in FIG. 26. For example, boosted coupled inductor 2500 may include an electrical conductor (not shown) electrically coupling boost windings 2508 and 2509 in series. As another example, boost windings 2508 and 2509 may be electrically coupled in series external to boosted coupled inductor 2500, such as by a printed circuit board (PCB) (not shown) supporting boosted coupled inductor 2500.

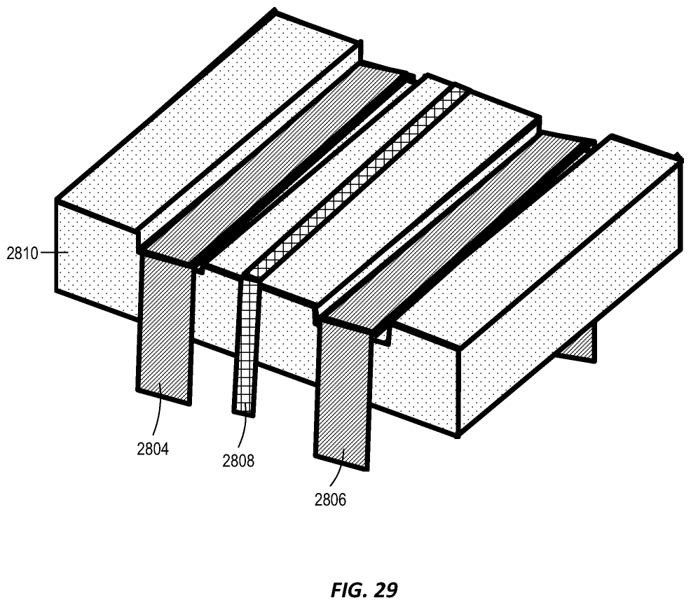

Boosted coupled inductors 900, 1700, 1900, 2000, 2200, and 2500 are scalable in that they can be configured to support any number of phases by adjusting the number of legs and power transfer windings. However, boosted coupled inductor 815 of FIG. 8 could also be a non-scalable boosted coupled inductor in embodiments of switching power converter 800 where N is equal to two. For example, FIG. 28 is a perspective view of a boosted coupled inductor 2800, which is another possible embodiment boosted coupled inductor 815 where N is equal to two. Boosted coupled inductor 2800 includes a magnetic core 2802, a first power transfer winding 2804, a second power transfer winding 2806, and a boost winding 2808. Power transfer windings 2804 and 2806 are each an embodiment of a power transfer winding 814, and boost winding 2808 is an embodiment of boost winding 811.

Magnetic core 2802 is formed, for example, of a ferrite magnetic material or a powdered iron magnetic material. Magnetic core 2802 includes a first element 2810 and a second element 2812 stacked in a direction 2814. FIG. 29 is a perspective view of boosted coupled inductor 2800 with second element 2812 removed to show an interior of boosted coupled inductor 2800. Magnetic core 2802 forms a passageway 2816 extending through magnetic core 2802 in a direction 2818, where direction 2818 is orthogonal to direction 2814. Passageway 2816 has a width 2820 in a direction 2822, where direction 2822 is orthogonal to each of directions 2814 and 2818. Magnetic core 2802 could be formed of a single element, or magnetic core 2802 could be formed of three of more elements, without departing from the scope hereof.

Each of first power transfer winding 2804, second power transfer winding 2806, and boost winding 2808 are wound through passageway 2816. Second power transfer winding 2806 is separated from first power transfer winding 2804 in direction 2822, and boost winding 2808 is disposed between first power transfer winding 2804 and second power transfer winding 2806 in direction 2822. In some embodiments, each of first power transfer winding 2804, second power transfer winding 2806, and boost winding 2808 is a staple style winding. Passageway 2816 has a height 2824 in direction 2814. In some embodiments, height 2824 varies along width 2820. For example, in certain embodiments, height 2824 at the boost winding 2808 is less than height 2824 at each of the first and second power transfer windings 2804 and 2806, to achieve requisite leakage inductance values. The configuration of boosted coupled inductor 2800 enables boost winding 2808 be strongly magnetically coupled to leakage elements of power transfer windings 2804 and 2806. In particular, boost winding 2808 forms a turn around leakage magnetic flux paths of power transfer windings 2804 and 2806. Additionally, boosted coupled inductor 2800 is capable of being operated such that net mutual magnetic flux flowing through the turn of boost winding 2808 is essentially zero.

Referring again to FIG. 8, controller 806 is implemented, for example, by analog and/or electronic circuitry. In some embodiments, controller 806 is at least partially implemented by a processor (not shown) executing instructions in the form of software and/or firmware stored in a memory (not shown). Although controller 806 is depicted as a discrete element for illustrative simplicity, controller 806 could be partially or fully integrated with one or more other elements of switching power converter 800. For example, some subsystems of controller 806 could be incorporated in one or more of switching stages 812. Additionally, FIG. 8 should not be construed to require that there be a separate control bus for each control signal. For example, controller 806 could be implemented by a combination of a central integrated circuit and local control logic integrated in each switching stage 812, with a single control bus running from the central integrated circuit to each switching stage 812. Furthermore, controller 806 may include multiple constituent elements that need not be co-packaged over even disposed at a common location

Controller 806 is configured to generate control signals U and L to control duty cycle of power stages 804, where duty cycle is a portion of a switching cycle that a power transfer winding 814 is driven high, to regulate at least one parameter of switching power converter 800. In some embodiments, controller 806 is configured to control duty cycle of power stages 804 using pulse width modulation and/or pulse frequency modulation. Examples of possible regulated parameters include, but are not limited, magnitude of input voltage Vᵢₙ, magnitude of input current Iᵢₙ, magnitude of output voltage Vₒ, and magnitude of output current Iₒ. For example, in some embodiments, controller 806 is configured to generate control signals U and L to regulate magnitude of output voltage Vₒ, and controller 806 accordingly generates control signals U and L during continuous conduction operation of switching power converter 800 such that duty cycle of power stages 804 is equal to a ratio of output voltage magnitude Vₒ over input voltage magnitude Vᵢₙ. For example, if output voltage Vₒ is to be regulated to two volts and input voltage Vi, is eight volts, controller 806 would generate control signals U and L such that duty cycle of power stages 804 is 0.25. Controller 806 is optionally configured to generate control signals U and L such that power stages 804 switch out-of-phase with each other. For example, in some embodiments, controller 806 is configured to generate control signals U and L such that each power stage 804 switches 360/N degrees out of phase with an adjacent power stage 804 in the phase domain.

Blocking capacitor 808 prevents direct current shorting of output power node 802 to reference node 820, while allowing alternating current to flow between boost winding 811 and output power node 802. Accordingly, in particular embodiments, blocking capacitor 808 has a sufficiently large capacitance value such that a corner frequency established by blocking capacitor 808 and tuning inductor 810 is significantly lower than a switching frequency of switching power converter 800, to enable injection of current flowing through boost winding 811 into output power node 802. Additionally, in certain embodiments, tuning inductor 810 has an inductance of L_{c}, where L_{c}=L_{co}/(N1/N2)². L_{co} is an inductance of tuning inductor 810 that would be selected if a ratio of N1/N2 were one instead of its actual value, such as to achieve a desired performance of switching power converter 800 if the ratio of N1/N2 were one instead of its actual value. As discussed below, in some applications, it may be desirable for the ratio of N1/N2 to be greater than N, instead of being equal to N.

Importantly, switching power converter 800 is configured such that current flowing through boost winding 811 at least partially cancels ripple current flowing through power transfer windings 814, at output power node 802. In particular, a respective direct current I_{DC} and a respective alternating current I_{AC} flow through each power transfer winding 814, as illustrated in FIG. 8. Under steady state operating conditions of switching power converter 800, each alternating current I_{AC} is a ripple current caused by switching of switching stages 812. The sum of direct current I_{DC} and alternating current I_{AC} flowing through a given power transfer winding 814 may be referred to as current 822 flowing through the power transfer winding, as illustrated in FIG. 8. Additionally, an injection current Iᵢₙⱼ, which is an alternating current, flows through boost winding 811, tuning inductor 810, and blocking capacitor 808, as illustrated in FIG. 8. Injection current Iᵢₙⱼ is also a ripple current under steady state operating conditions of switching power converter 800. Injection current Iᵢₙⱼ is injected into output power node 802. Boost winding 811 is electrically coupled to output power node 802 such that injection current Iᵢₙⱼ is at least substantially out-of-phase with respect to alternating currents I_{AC} flowing through power transfer windings 814. Additionally, as discussed above, in particular embodiments, a ratio of N1 to N2 is equal to N, such as that magnitude of injection current Iᵢₙⱼ is substantially equal to a magnitude of a sum of all alternating currents I_{AC} flowing through power transfer windings 814. Accordingly, injection current Iᵢₙⱼ may significantly cancel alternating currents I_{AC} at output power node 802, thereby advantageously helping minimize magnitude of ripple in output current Iₒ.

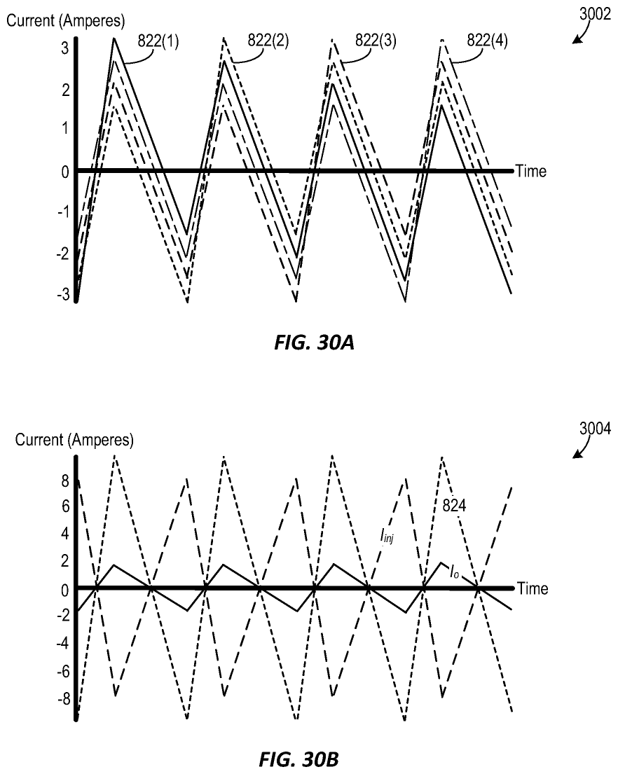

For example, FIGS. 30A and 30B are graphs 3002 and 3004, respectively, of current versus time of simulated operation of one embodiment of switching power converter 800 where N=4, switching frequency is one MHz, magnetizing inductance (Lₘ) of boosted coupled inductor 815 is 400 nH, each power transfer winding 814 has a leakage inductance (Lₛ) of 150 nH, N1/N2=4, Vᵢₙ=12 volts, Vₒ=1 volt, and inductance (L_{c}) of tuning inductor 130 is 7.5 nH. Graphs 3002 and 3004 have a common time base. Graph 3002 includes curves representing each of currents 822(1), 822(2), 822(3) and 822(4) flowing through power transfer windings 814(1), 814(2), 814(3), and 814(4), respectively. Graph 3004 includes curves representing (a) total current 824 flowing through all power transfer windings 814 (see FIG. 8) assuming zero load at the converter output, (b) injection current Iᵢₙⱼ injected into output power node 802, and (c) output current Iₒ for the zero load at the converter output. Total current 824 has a peak-to-peak ripple current magnitude of around 18 amperes, as illustrated in FIG. 30B. If injection current Iᵢₙⱼ were not injected into output power node 802, output current Iₒ would be the same as total current 824, and output current Iₒ would therefore also have a peak-to-peak ripple current magnitude of around 18 amperes. However, injection current Iᵢₙⱼ is out-of-phase with respect to total current 824, and peak-to-peak magnitude of injection current Iᵢₙⱼ is almost as large as the peak-to-peak magnitude of total current 824. Therefore, injection current Iᵢₙⱼ substantially cancels ripple current flowing through power transfer windings 814, at output power node 802. Consequently, output current Iₒᵤₜ has a relatively small ripple current magnitude of only around 3.3 amperes. As such, injecting injection current Iᵢₙⱼ into output power node 802 substantially reduces magnitude of ripple in output current Iₒ.

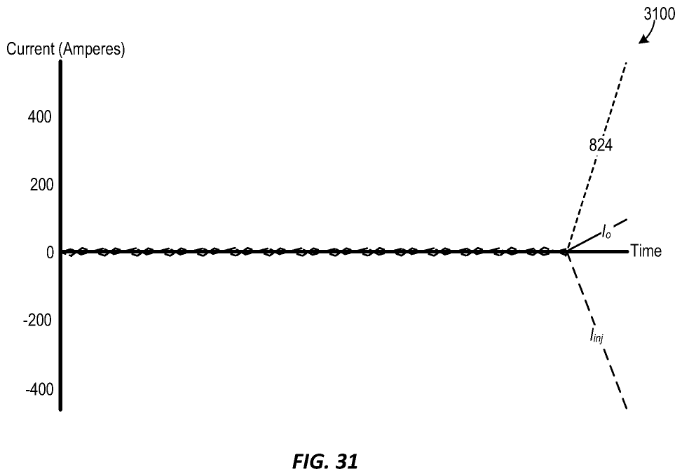

While injection of injection current Iᵢₙⱼ into output power node 802 reduces magnitude of ripple in output current Iₒ, such injection also degrades transient response of switching power converter 800 in a manner analogous to that discussed above with respect to switching power converter 100. For example, FIG. 31 is a graph 3100 of current versus time illustrating simulated operation of an embodiment of switching power converter 800 in response to a change in load. Prior to time t₁, a load powered by switching power converter 800 is zero, and magnitude of output current Iₒ is therefore zero. At time t₁, though, the load powered by switching power converter 800 rapidly increases, and total current 824 therefore ramps up. However, injection current Iᵢₙⱼ injected into output power node 802 ramps up in the opposite direction of total current 824, and the injected current therefore slows the rise of output current Iₒ in response to the load increase, thereby degrading the transient response of switching power converter 800.

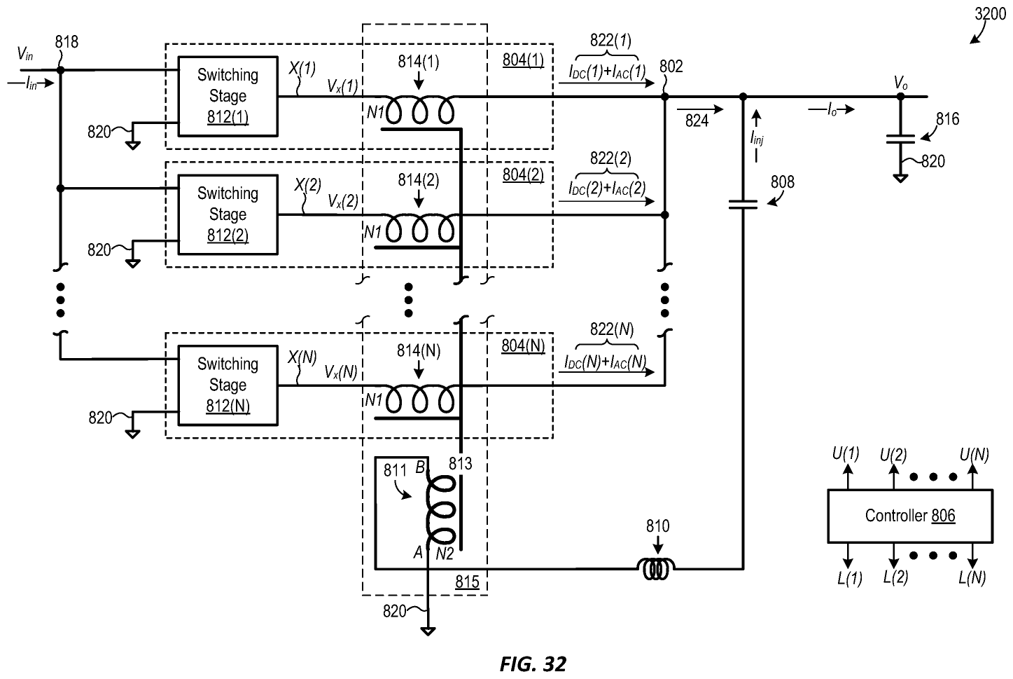

Switching power converter 800 can be modified so that injection current Iᵢₙⱼ adds to alternating currents I_{AC} in output power node 802, instead of subtracting from (canceling) alternating currents I_{AC} in output power node 802, thereby promoting fast transient response to the switching power converter at the expensive of larger magnitude of ripple in output current Iₒ. For example, FIG. 32 is a schematic diagram of switching power converter 3200, which is an alternate embodiment of switching power converter 800 that is optimized for fast transient response instead of for low ripple current magnitude. Switching power converter 3200 differs from switching power converter 800 only in the manner that boost winding 811 is electrically coupled to output power node 802. In particular, in switching power converter 800 (FIG. 8), boost winding 811 is electrically coupled between output power node 802 and reference node 820 such that injection current Iᵢₙⱼ is out of phase with respect to alternating currents I_{AC} flowing through power transfer windings 814. In switching power converter 3200 (FIG. 32), in contrast, boost winding 811 is electrically coupled between output power node 802 and reference node 820 such that injection current Iᵢₙⱼ adds to alternating currents I_{AC} flowing through power transfer windings 814, thereby promoting fast transient response of switching power converter 3200 with the potential drawback of larger magnitude of ripple in output current Iₒ. It should be noted, though, that magnitude of ripple current decreases with increasing number of phases of switching power converter 3200. Therefore, in embodiments of switching power converter 3200 where N is large, increase in magnitude of ripple in output current Iₒ caused by injecting injection current Iᵢₙⱼ into output power node 802 may be immaterial because ripple current magnitude is very small due to N being large.

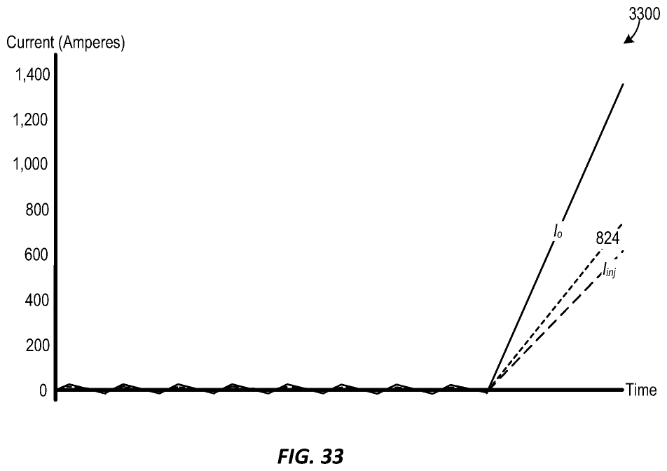

FIG. 33 is a graph 3300 of current versus time illustrating simulated operation of an embodiment of switching power converter 3200 in response to a change in load. Prior to time t₁, a load powered by switching power converter 3200 is zero, and magnitude of output current Iₒ is therefore zero (neglecting ripple current). At time t₁, though, the load powered by switching power converter 3200 rapidly increases, and total current 824 therefore ramps up. Additionally, injection current Iᵢₙⱼ injected into output power node 802 ramps up in the same direction as total current 824, and the injected current thereby adds to total current 824 and increases the rate of rise of output current Iₒ in response to the load increase, thereby improving the transient response of switching power converter 3200. However, the fact that injection current Iᵢₙⱼ adds to alternating currents I_{AC} flowing through power transfer windings 814 increases magnitude of ripple in output current 10.

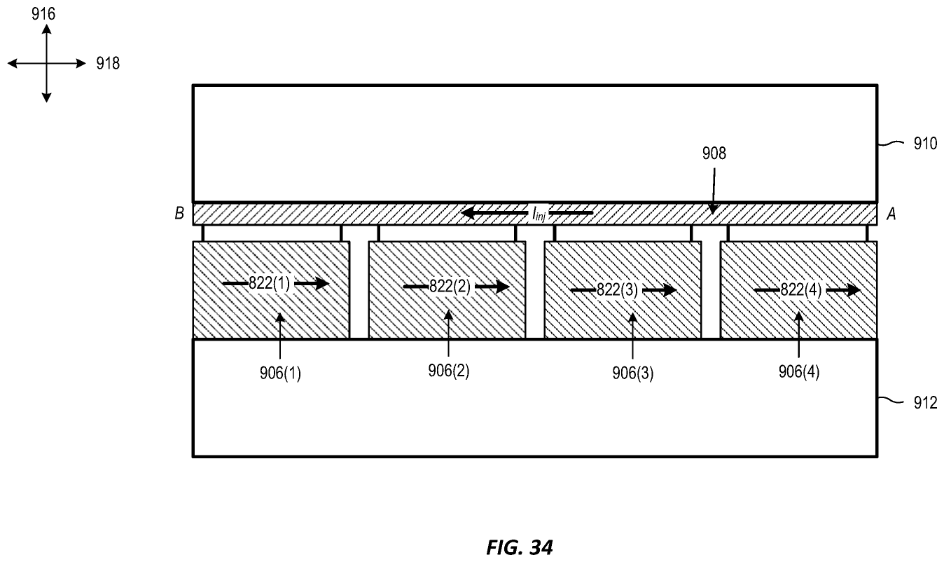

FIG. 34 is a top plan view of boosted coupled inductor 900 (FIG. 9) illustrating one example of how electrical connections to a boost winding can be varied to achieve either a switching power converter optimized for low ripple current magnitude or a switching power converter optimized for fast transient response. FIG. 34 assumes that (a) boosted coupled inductor 815 of switching power converters 800 and 3200 is embodied by boosted coupled inductor 900 and (b) N=4 in switching power converters 800 and 3200. It is understood, though, that switching power converters 800 and 3200 are not limited to use with boosted coupled inductor 900 or to N=4. FIG. 34 assumes that power transfer windings 906, which are embodiments of power transfer windings 814, are connected such that currents 822 flow from left to right when boosted coupled inductor 900 is viewed from its top, as illustrated in FIG. 34. In this scenario, injection current Iᵢₙⱼ flowing through boost winding 908, where boost winding 908 is an embodiment of boost winding 811, flows from right to left, as illustrated in FIG. 34. Accordingly, if boosted coupled inductor 900 is used switching power converter 800, end A of boost winding 908 is electrically coupled to output power node 802 and end B of boost winding 908 is electrically coupled to reference node 820, as illustrated in FIG. 8, so that injection current Iᵢₙⱼ at least partially cancels alternating currents I_{AC} flowing through power transfer windings 814. On the other hand, if boosted coupled inductor 900 is used switching power converter 3200, end B of boost winding 908 is electrically coupled to output power node 802 and end A of boost winding 908 is electrically coupled to reference node 820, as illustrated in FIG. 32, so that injection current Iᵢₙⱼ adds to alternating currents I_{AC} flowing through power transfer windings 814.

As discussed above, magnitude of injection current Iᵢₙⱼ is substantially equal to a magnitude of a sum of all alternating currents I_{AC} flowing through power transfer windings 814 if a ratio of N1 to N2 is equal to N. However, this condition applies only when boost winding 811 is perfectly magnetically coupled to power transfer windings 814, or on in other words, when boosted coupled inductor 815 has infinite magnetizing inductance Lₘ. A practical implementation of boosted coupled inductor 815, though, will not achieve infinite magnetizing inductance Lₘ, and magnitude of injection current Iᵢₙⱼ therefore will not be identical to a magnitude of a sum of all alternating currents I_{AC} flowing through power transfer windings 814 if a ratio of N1 to N2 is equal to N.

As such, it may be desirable to configure boosted coupled inductor 815 such that a ratio of N1 to N2 is larger than N to compensate for magnetizing inductance Lₘ of boosted coupled inductor 815 being finite. However, while increasing the ratio of N1 to N2 beyond N to a degree may improve operation of multi-phase switching power converter 800 or 3200, increasing the ratio of N1 to N2 too much degrades performance of the switching power converter 800 or 3200. Accordingly, there will typically be an optimal ratio of N1 to N2 that is greater than N, but is not too large, to compensate for magnetizing inductance of boosted coupled inductor 815 being finite.

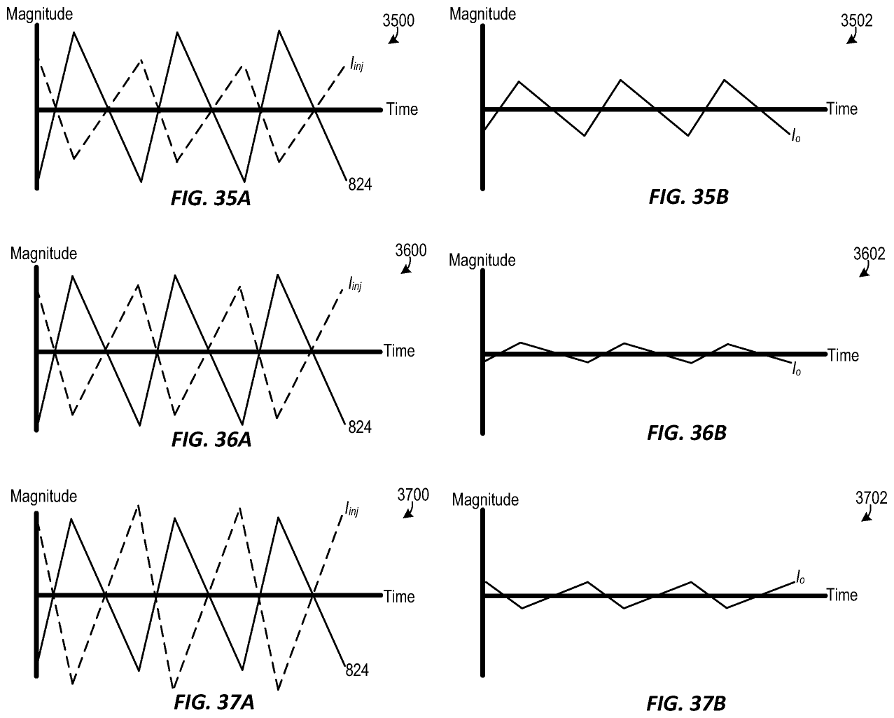

For example, FIGS. 35A-37B collectively illustrate three examples of how ratio of N1 to N2 affects operation of switching power converter 800. Specifically, FIGS. 35A and 35B illustrate a first example where (a) N=4, (b) there is no load on switching power converter 800, and (c) a ratio of N1 to N2 is smaller than optimal, such as due to finite magnetizing inductance Lₘ of boosted coupled inductor 815. FIG. 35A is a graph 3500 of magnitude versus time including curves representing (a) total current 824 flowing through all power transfer windings 814 (see FIG. 8) and (b) injection current Iᵢₙⱼ injected into output power node 802. FIG. 35B is a graph 3502 of magnitude versus time including a curve representing output current Iₒ. As evident from FIGS. 35A and 35B, injection current Iᵢₙⱼ helps cancel ripple current flowing through power transfer windings 814, but the cancelation is not ideal.

FIGS. 36A and 36B illustrate a second example where (a) N=4, (b) there is no load on switching power converter 800, and (c) a ratio of N1 to N2 is larger than in the example of FIGS. 35A and 35B, such as greater than 4. FIG. 36A is a graph 3600 of magnitude versus time including curves representing (a) total current 824 flowing through all power transfer windings 814 and (b) injection current Iᵢₙⱼ injected into output power node 802. FIG. 36B is a graph 3602 of magnitude versus time including a curve representing output current Iₒ. As evident when comparing FIGS. 35B and 36B, increasing the ratio of N1 to N2 from the value of FIGS. 35A and 35B to the value of FIGS. 36A and 36B significantly decreased ripple in output current Iₒ.

FIGS. 37A and 37B illustrate a third example where (a) N=4, (b) there is no load on switching power converter 800, and (c) a ratio of N1 to N2 is larger than in the example of FIGS. 36A and 36B. FIG. 37A is a graph 3700 of magnitude versus time including curves representing (a) total current 824 flowing through all power transfer windings 814 and (b) injection current Iᵢₙⱼ injected into output power node 802. FIG. 37B is a graph 3702 of magnitude versus time including a curve representing output current Iₒ. As evident when comparing FIGS. 36B and 37B, increasing the ratio of N1 to N2 from the value of FIGS. 36A and 36B to the value of FIGS. 37A and 37B increased ripple in output current Iₒ and changed polarity of output current Iₒ. Therefore, the ratio of N1 to N2 in the example of FIGS. 37 and 37B is too large, and the optimal value of the ratio of N1 to N2 is between (a) the value of the example of FIGS. 36A and 36B and (b) the value of the example of FIGS. 37A and 37B.

Referring again to FIG. 8, in some applications, it may be desirable for N1 to be less than N. For example, in high current applications, it may be desirable for N1 to be equal to one to minimize conduction losses in power transfer windings 814. However, it is not feasible for the ratio of N1 to N2 to be equal to N, or to be greater than N, if N1 is less than N, due to impracticality of implementing a fractional value of N2. Consequently, is not feasible to select a ratio of N1 to N2 where magnitude of injection current Iᵢₙⱼ is substantially equal to a magnitude of a sum of all alternating currents I_{AC} flowing through power transfer windings 814 if N1 is less than N.

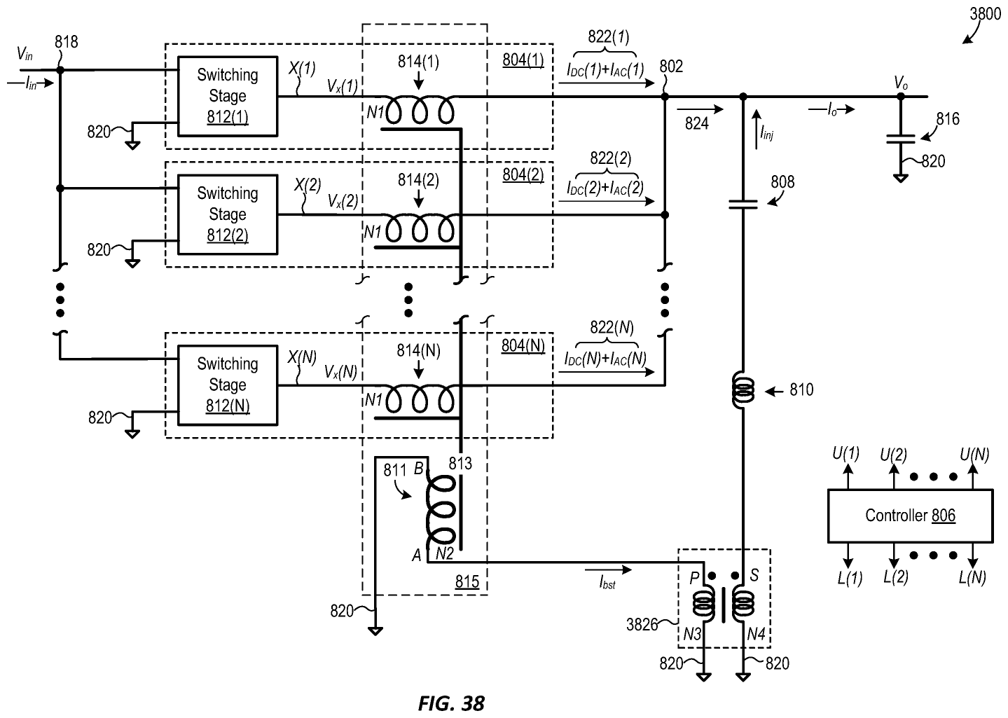

Applicant has found that the aforementioned limitation can be overcome by including a transformer electrically coupled in series with boost winding 811 to enable additional freedom in setting the relationship between magnitude of injection current Iᵢₙⱼ and magnitude of currents 822 flowing through power transfer windings 814. For example, FIG. 38 is a schematic diagram of a multi-phase switching power converter 3800, which is an alternate embodiment of switching power converter 800 (FIG. 8) further including a transformer 3826. Transformer 3826 includes a primary winding P and a secondary winding S. Primary winding P forms a quantity of turns equal to N3, and secondary winding S forms a quantity of turns equal to N4. Primary winding P of transformer 3826 is electrically coupled in series with boost winding 811, and each of boost winding 811 and primary winding P of transformer 3826 is also electrically coupled to reference node 820. Secondary winding S of transformer 3826 is electrically coupled in series with blocking capacitor 808 and tuning inductor 810, and secondary winding S of transformer 3826 is also electrically coupled to reference node 820. Accordingly, boost winding 811 is electrically coupled in series with blocking capacitor 808 via transformer 3826.

A ratio of current I_{bst} flowing through boost winding 811 to injection current Iᵢₙⱼ is given by the following relationship: Iᵢₙ=(I_{bst})*(N3/N4). Consequently, magnitude of injection current Iᵢₙⱼ is substantially equal to a magnitude of a sum of all alternating currents I_{AC} flowing through power transfer windings 814 if the following relationship holds true, assuming boosted coupled inductor 815 has infinite magnetizing inductance Lₘ: (N1/N2)*(N3/N4)=N. As such, switching power converter 3800 can be configured so that magnitude of injection current Iᵢₙⱼ is substantially equal to a magnitude of a sum of all alternating currents I_{AC} flowing through power transfer windings 814 even if N1 is less than N, with proper selection of N3 and N4. For example, if N1 is equal to one and N2 and N4 are each equal to one for simplicity, N3 may be equal to N to satisfy the following relationship: (N1/N2)*(N3/N4)=N. In some applications, it may be desirable for the quantity (N1/N2)*(N3/N4) to be somewhat greater than N to compensate for boosted coupled inductor 815 having finite leakage inductance, for reasons analogous to those discussed above with respect to multi-phase switching power converters 800 and 3200. In a manner analogous to that discussed above with respect to switching power converter 800, the respective topological locations of blocking capacitor 808, tuning inductor 810, and secondary winding S of transformer 3826 may vary as long as these three elements are electrically coupled in series between output power node 802 and reference node 820.

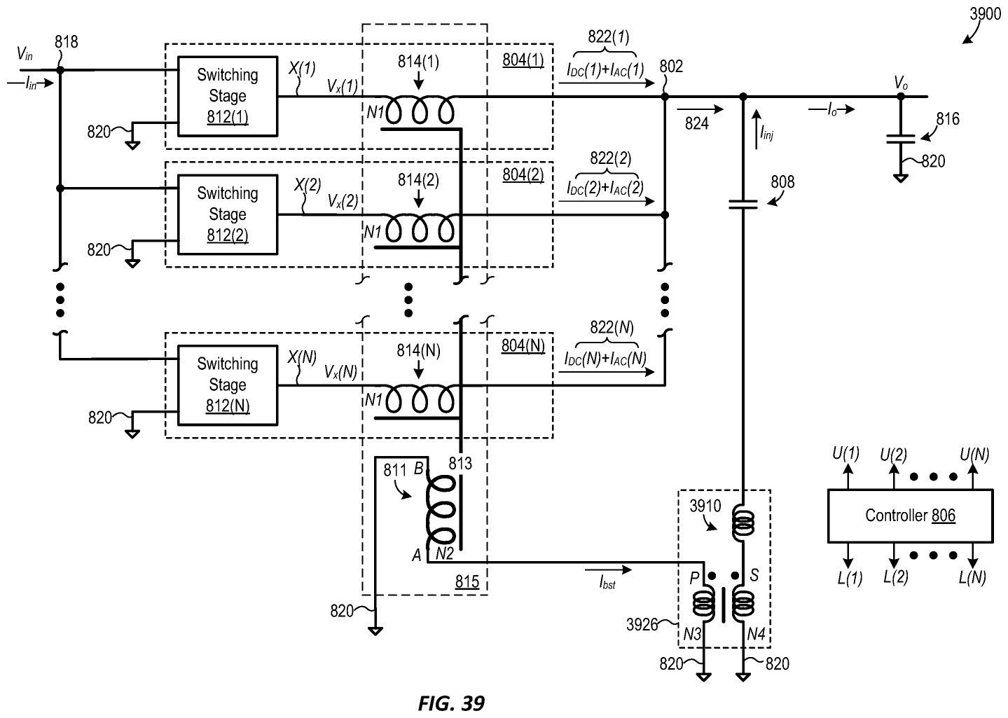

While tuning inductor 810 is a discrete element in switching power converter 3800, tuning inductor 810 could alternately be implemented by leakage inductance of transformer 3826. For example, FIG. 39 is a schematic diagram of a multi-phase switching power converter 3900, which is an alternate embodiment of switching power converter 3800 (FIG. 3) where transformer 3826 is replaced with a transformer 3926. Transformer 3926 is configured to implement tuning inductor 810 by leakage inductance 3910 of transformer 3926, and tuning inductor 810 is therefore omitted. Transformer 3926 is configured, for example, such that leakage inductance 3910 has an inductance of Lₛ, where Lₛ=L_{co}/(N1/N2*N3/N4)². L_{co} is an inductance of leakage inductance 3910 that would be selected if a value of (N1/N2*N3/N4) were one instead of its actual value, such as to achieve a desired performance of switching power converter 3900 if the value of (N1/N2*N3/N4) were one instead of its actual value. Switching power converter 3200 (FIG. 32) could be modified to further include a transformer in a manner similar to switching power converter 3800 or 3900.

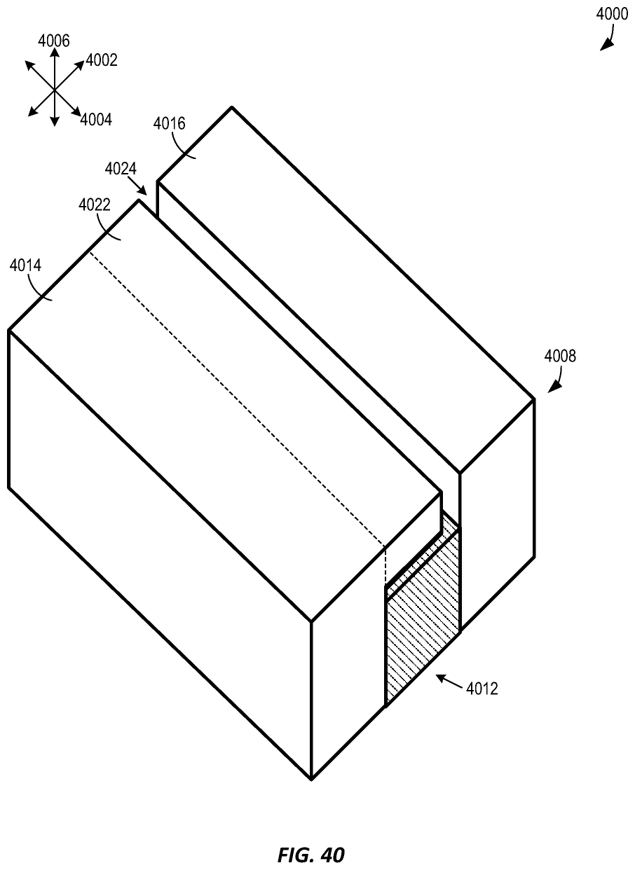

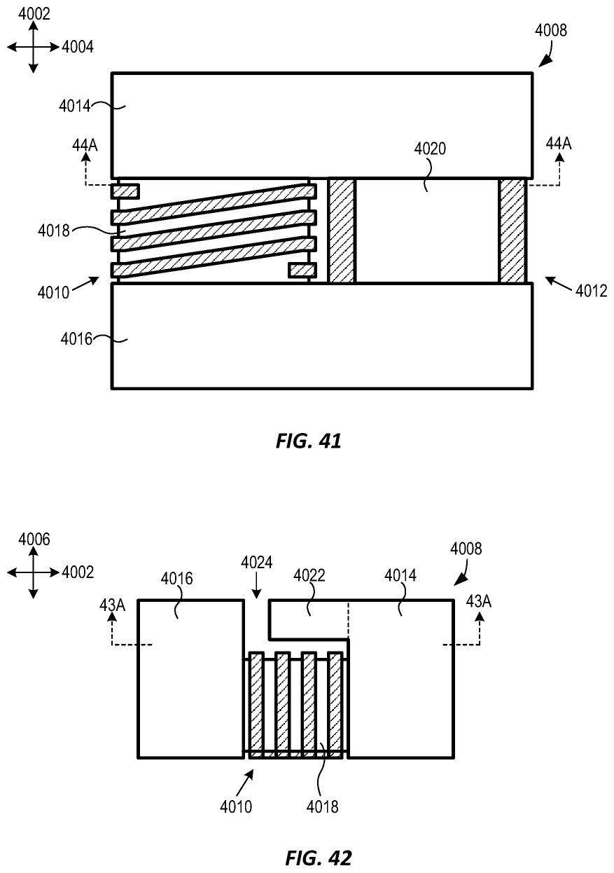

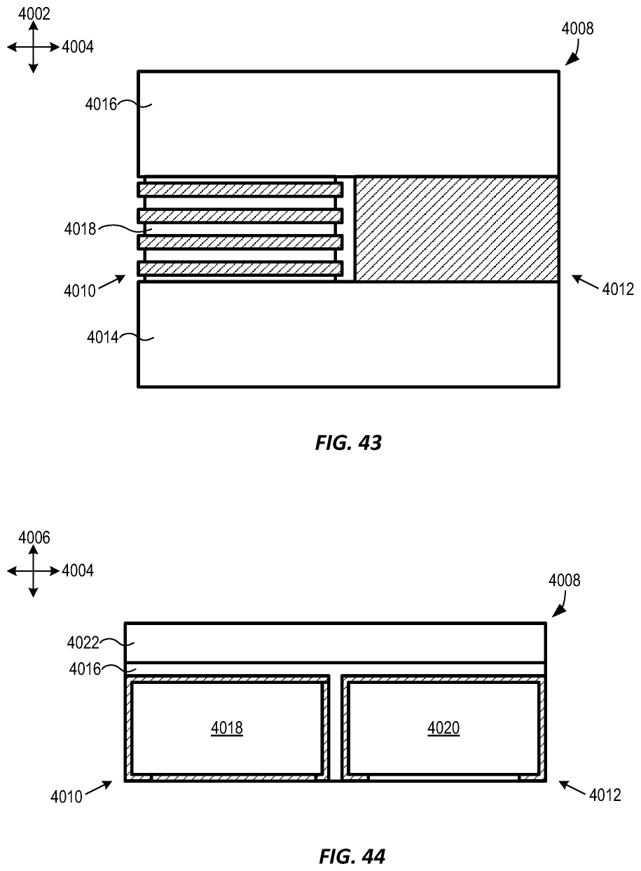

FIGS. 40-44 collectively illustrate a transformer 4000, which is one possible embodiment of transformer 3926 of FIG. 39. FIG. 40 is a perspective view of transformer 4000, FIG. 41 is a bottom plan view of transformer 4000, FIG. 42 is a side elevational view of transformer 4000, FIG. 43 is a cross-sectional view of transformer 4000 taken along line 43A-43A of FIG. 42, and FIG. 44 is a cross-sectional view of transformer 4000 taken along line 44A-44A of FIG. 41. FIGS. 40-44 collectively illustrate three directions 4002, 4004, and 4006, where (i) direction 4002 is orthogonal to each of directions 4004 and 4006, (ii) direction 4004 is orthogonal to each of directions 4002 and 4008, and (ii) direction 4006 is orthogonal to each of directions 4002 and 4004.

Transformer 4000 includes a magnetic core 4008, a winding 4010 (see FIGS. 41, 42, 43, and 44) and a winding 4012 (see FIGS. 40, 41, 43, and 44). Magnetic core 4008 includes a first rail 4014 (see FIGS. 40-43), a second rail 4016 (see FIGS. 40-44), a first leg 4018 (see FIGS. 41-44), a second leg 4020 (see FIGS. 41 and 44), and a leakage element 4022 (see FIGS. 40, 42, and 44). Magnetic core 4008 is formed, for example, of a ferrite magnetic material or a powdered iron magnetic material. First rail 4014 and second rail 4016 are separated from each other in direction 4002, and each of first leg 4018 and second leg 4020 is disposed between first rail 4014 and second rail 4016 in direction 4002. First leg 4018 is separated from second leg 4020 in direction 4004. In other embodiments, first leg 4018 and/or second leg 4020 are separated from first rail 4014 and/or second rail 4016 by a respective gap (not shown), such as to help prevent saturation of magnetic core 4008. Each of first leg 4018 and second leg 4020 optionally also forms a respective gap (not shown) along direction 4004, such that the leg is broken into two or more portions separated from each other in direction 4002 by the gap.

Winding 4010 is wound around leg 4018, and winding 4012 is wound around leg 4020. Winding 4010 is an embodiment of primary winding P of transformer 3926, and winding 4012 is an embodiment of secondary winding S of transformer 3926. Winding 4010 is depicted as forming a plurality of turns, while winding 4012 is depicted as being a single-turn winding. However, the quantity of turns formed windings 4010 and 4012 may vary.

Leakage element 4022 is joined to first rail 4014, and leakage element 4022 extends towards second rail 4106 in direction 4002 provide a relatively low reluctance path for leakage magnetic flux to flow between first rail 4014 and second rail 4016. Leakage element 4022 is separated from second rail 4106 by a gap 4024 in direction 4002 where gap 4024 is filled with, for example, air, paper, plastic, adhesive, and/or a magnetic material having a lower magnetic permeability that magnetic material forming leakage element 4022. Gap 4024 can be split into two or more smaller gaps to decrease the fringing flux. The dotted lines delineating leakage element 4022 from first rail 4014 are to assist a viewer in distinguishing features of transformer 4000, and these lines do not necessarily represent discontinuities in transformer 4000. Leakage inductance of transformer 4000, which is an embodiment of leakage inductance 3910 of FIG. 39, can be controlled, for example, by the configuration of gap 4024. For example, leakage inductance of transformer 4000 can be increased by decreasing thickness of gap 4024 in direction 4002 and/or by increasing cross-sectional area of leakage element 4022 in a plane extending in directions 4004 and 4006.

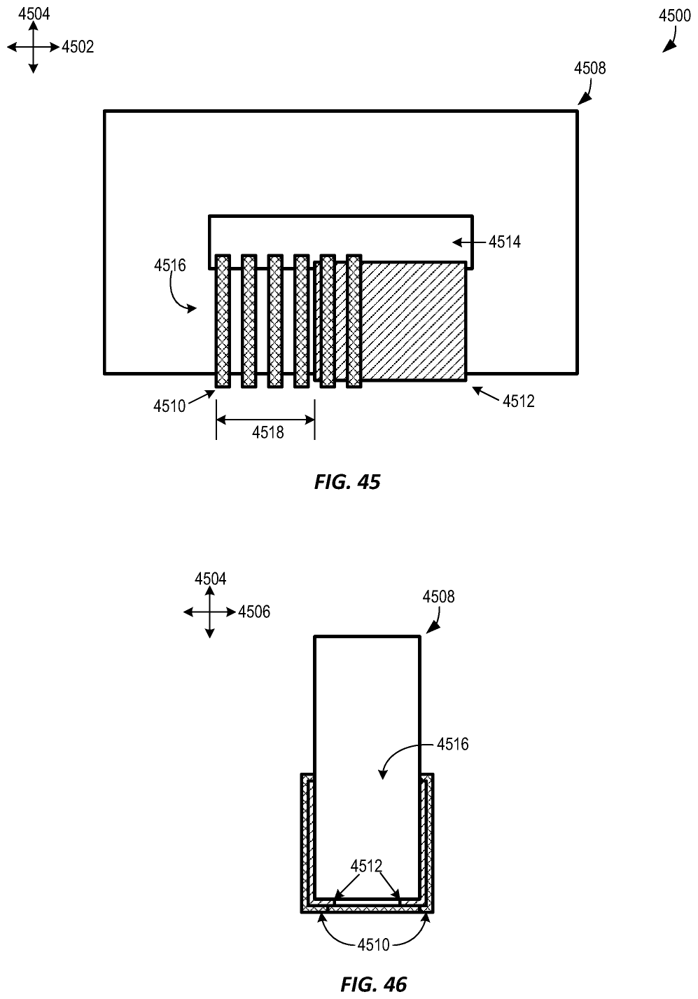

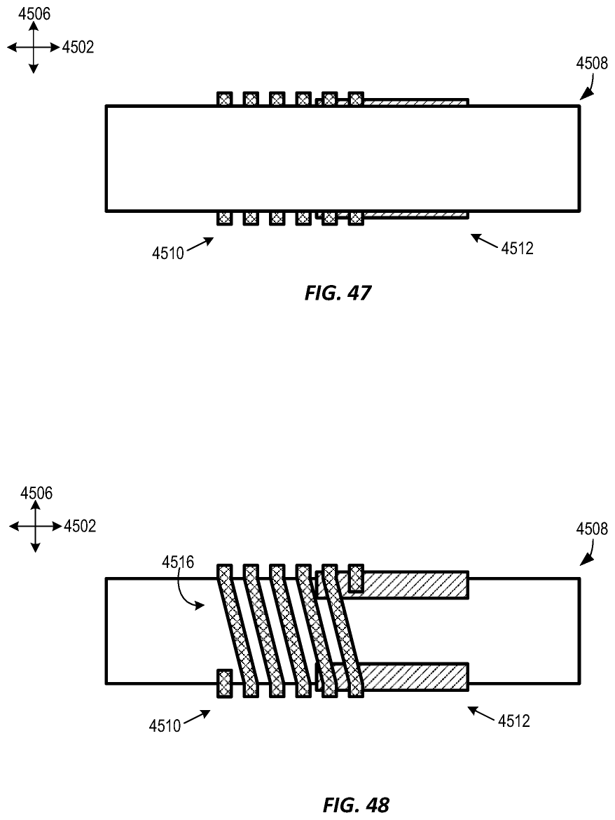

However, it may not be possible to obtain sufficiently low leakage inductance in some applications of transformer 4000, such as when a ratio of N3 (quantity of turns formed by winding 4010) to N4 (quantity of turns formed by winding 4012) is large. FIGS. 45-48 collectively illustrate a transformer 4500, which is another embodiment of transformer 3926 and can achieve lower leakage inductance than transformer 4000. FIG. 45 is a front elevational view of transformer 4500, FIG. 46 is a side elevational view of transformer 4500, FIG. 47 is a top plan view of transformer 4500, and FIG. 48 is a bottom plan view of transformer 4500. FIGS. 45-48 collectively illustrate three directions 4502, 4504, and 4506, where (i) direction 4502 is orthogonal to each of directions 4504 and 4506, (ii) direction 4504 is orthogonal to each of directions 4502 and 4508, and (ii) direction 4506 is orthogonal to each of directions 4502 and 4504.

Transformer 4500 includes a magnetic core 4508, a winding 4510, and a winding 4512. Magnetic core 4508 is formed, for example, of a ferrite magnetic material or a powdered iron magnetic material. Magnetic core 4508 forms a passageway 4514 extending through magnetic core 4508 in direction 4506, and magnetic core 4508 optionally forms one or more gaps (not shown) to help prevent saturation of magnetic core 4508. Each of winding 4510 and winding 4512 is wound through passageway 4514 and around a leg 4516 of magnetic core 4508. Winding 4510 is an embodiment of primary winding P of transformer 3926, and winding 4512 is an embodiment of secondary winding S of transformer 3926. Winding 4510 is depicted as forming a plurality of turns, while winding 4512 is depicted as being a single-turn winding. However, the quantity of turns formed windings 4510 and 4512 may vary.

Winding 4510 is depicted as partially overlapping winding 4512, or stated differently, winding 4510 is depicted as being partially wound over winding 4512, although winding 4510 is electrically isolated from winding 4512. FIG. 45 also illustrates an offset 4518 of winding 4510 with respect to winding 4510, where offset 4518 is proportional to an extent that winding 4510 does not overlap winding 4512. Leakage inductance of transformer 4500 is minimized if winding 4510 completely overlaps winding 4512, and leakage inductance of transformer 4500 is therefore a function of offset 4518. For example, leakage inductance of transformer 4500 will decrease as offset 4518 is decreased, and leakage inductance of transformer 4500 will increase as offset 4518 is increased.

Transformer 3926 (FIG. 39) could be embodied in manners other than those discussed above with respect to FIGS. 40-48 as long as a required turns ratio and leakage inductance can be achieved. For example, primary winding P and/or secondary winding S of transformer 3926 could be embodied by windings in a substrate, such as PCB windings. It may be particularly advantageous to embody windings of transformer 3926 by PCB windings in applications where low leakage inductance of transformer 3926 is required because PCB windings can typically be configured in a manner that achieves low leakage inductance. Additionally, leakage inductance of PCB windings is usually readily adjustable during PCB design, and PCB windings can achieve tightly controlled and repeatable leakage inductance values in typical manufacturing environments.

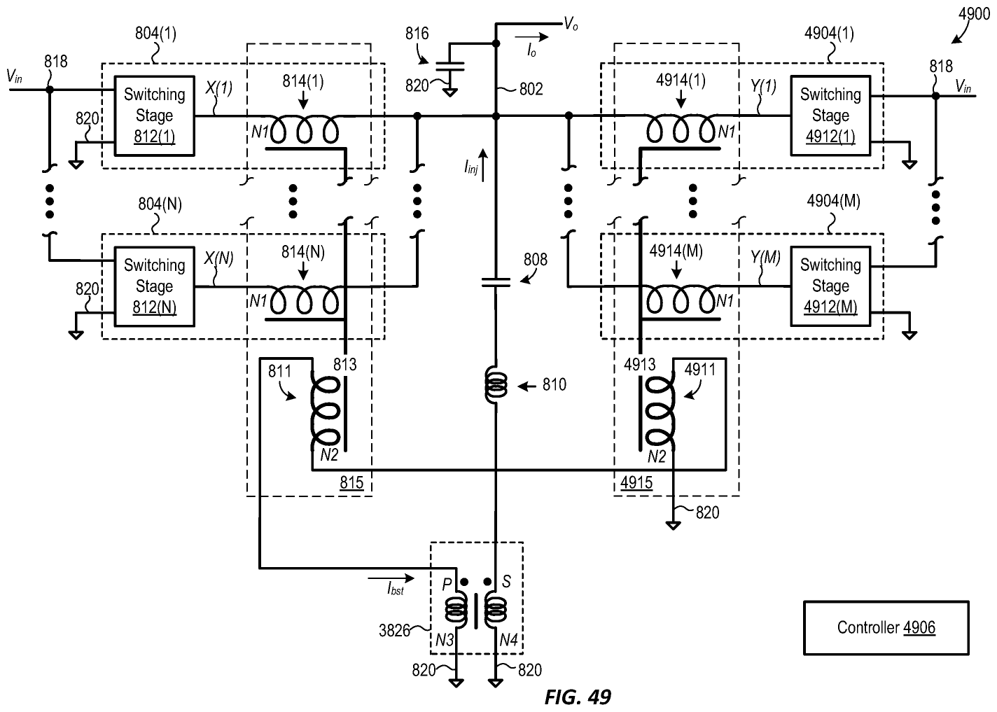

Referring again to FIGS. 38 and 39, switching power converters 3800 or 3900 could be modified to include one or more additional boosted coupled inductors. For example, FIG. 49 is a schematic diagram of a multi-phase switching power converter 4900, which is an alternate embodiment of multi-phase switching power converter 3800 further including M power stages 4904 and a boost winding 4911, where M is an integer greater than one. In some embodiments, M is the same as N, and in some other embodiments, M is different from N. Each power stage 4904 corresponds to a respective phase of switching power converter 4900, such that switching power converter includes N+M phases, i.e., N phases associated with power stages 804 and M phases associated with power stages 4904. Switching power converter 4900 further includes a controller 4906 in place of controller 806. Control signals generated by controller 4906 are not shown in FIG. 49 for illustrative clarity.

Each power stage 4904 includes a switching stage 4912 electrically coupled to a power transfer winding 4914 at a switching node Y. Each power transfer winding 4914 is electrically coupled between the switching node Y of its respective power stage 4904 and output power node 802. Each switching stage 4912 is configured to repeatedly switch the switching node Y of its power stage 4904 between input power node 818 and reference node 820, in response to control signals (not shown) generated by controller 4906. For example, switching stage 4912(1) is configured to repeatedly switch node Y(1) between input power node 818 and reference node 820 in response to control signals (not shown) generated controller 4906. Controller 4906 is also configured to generate control signals to control switching stages 812 in a manner analogous to how controller 806 generates control signals to control switching stages 812 in switching power converter 800.

Boost winding 811, boost winding 4911, and primary winding P of transformer 3826 are electrically coupled in series, and a closed circuit including these three elements is partially embodied by reference node 820. In some alternate embodiments, boost winding 811, boost winding 4911, and primary winding P of transformer 3826 are electrically coupled in series without being electrically coupled to reference node 820.

Power transfer windings 4914 are magnetically coupled by a magnetic core 4913. Boost winding 4911 is magnetically coupled to a leakage component (not illustrated in FIG. 49) of each power transfer winding 4914 by magnetic core 4913. In particular, boost winding 4911 is configured such that it forms at least one turn around a respective total magnetic flux path of each power transfer winding 4914. Boost winding 4911 is additionally configured such that net mutual magnetic flux within the turns of the boost winding is essentially zero during steady state operation of switching power converter 4900. Equivalently, boost winding 4911 can be configured such that it forms at least one turn around only a respective leakage magnetic flux path of each power transfer winding 4914. In some embodiments, boosted coupled inductor 4915 is embodied by one of boosted coupled inductors 900, 1700, 1900, 2000, 2200, 2500, or 2800, discussed above. Importantly, each boosted coupled inductor of switching power converter 4900 has a common turns ratio. Specifically, each power transfer winding 814 and each power transfer winding 4914 forms common a quantity of turns equal to N1, and each boost winding 811 and each boost winding 4911 forms a common quantity of turns equal to N2.

In view of switching power converter 4900 including two boosted coupled inductors configured to cancel the output current ripple from the main phases, magnitude of injection current Iᵢₙ; is substantially equal to a magnitude of a sum of all alternating currents I_{AC} flowing through power transfer windings 814 and power transfer windings 4914 if the following relationship holds true, assuming that each of boosted coupled inductor 815 and boosted coupled inductor 4915 has infinite magnetizing inductance Lₘ: (N1/N2)*(N3/N4)=QP, where QP is total quantity of phases in the switching power converter and is therefore equal to N+M in switching power converter 4900. It should be noted that switching power converter 4900 could be modified to include one or more additional boosted coupled inductors with boost windings electrically coupled in series with primary winding P of transformer 3826, which would result in the switching power converter 4900 including additional phases and QP therefore being larger than the sum of N+M. In some applications, it may be desirable for the quantity (N1/N2)*(N3/N4) to be somewhat greater than QP to compensate for boosted coupled inductor 815 and boosted coupled inductor 4915 each having finite leakage inductance, for reasons analogous to those discussed above with respect to multi-phase switching power converters 800 and 3200.

In some embodiments of switching power 4900, tuning inductor 810 has an inductance of L_{c}, where L_{c}=L_{c0}/(PH)². L_{c0} is an inductance of tuning inductor 810 that would be selected if a ratio of (N1/N2)*(N3/N4) were one instead of its actual value, such as to achieve a desired performance of switching power converter 4900 if the ratio of (N1/N2)*(N3/N4) were one instead of its actual value. As discussed above, in some applications, it may be desirable for the ratio of (N1/N2)*(N3/N4) to be greater than QP, instead of being equal to QP.

In an alternate embodiment, switching power converter 4900 is configured such that injected current Iᵢₙⱼ flowing through secondary winding S of transformer 3826, tuning inductor 810, and blocking capacitor 808 adds to the current flowing through power transfer windings 814 and 9414, which increases output current Iₒ during a transient loading or unloading event, thereby promoting fast transient response of switching power converter 4900. In this alternate embodiment, injected current Iᵢₙⱼ does not have to ideally match the total current ripple from the main phases and therefore the turns ratio of transformer 3826 does not have to be approximately equal (N1/N2)*(N3/N4)=PH. Increasing the turns ratio of transformer 3826 should generally increase the total output current Iₒ during a transient loading or unloading event, but increasing the turns ratio too much can cause limitations in terms of parasitics in transformer 3826, or in transient current slew rate.

As mentioned above, switching power converter 4900 could be modified to include one or more additional boosted coupled inductors sharing transformer 3826, i.e., where the respective boost winding of each boosted coupled inductor is electrically coupled in series with primary winding P of transformer 3826. Switching power converter 4900 could also be modified to include two or more inductor-transformer sets, where each set includes a respective transformer 3826 and one or more respective boosted coupled inductors, where the boost winding of each boosted coupled inductor of the set is electrically coupled in series with the primary winding P of the respective transformer 3826 of the set. In these alternate embodiments, the power transfer windings of the one or more respective boosted coupled inductors of each set are, for example, electrically coupled to output power node 802. The respective turns ratio and inductance of tuning inductor 810 for each set are determined, for example, as discussed above with respect to FIG. 49.

Referring again to FIGS. 1, 6, 8, 32, 38, 39, and 49, while the switching power converters discussed above have a buck-type topology, the concept of injecting current into a power node is not limited to use in a buck-type topology. Instead, injection current could be injected into a power node in other topologies where current flowing through a plurality of windings sums at a power node. It should be noted that injection current could be injected to a power node other than an output power node, such as an input power node, in certain topologies.

### Switching Power Converters With Injection

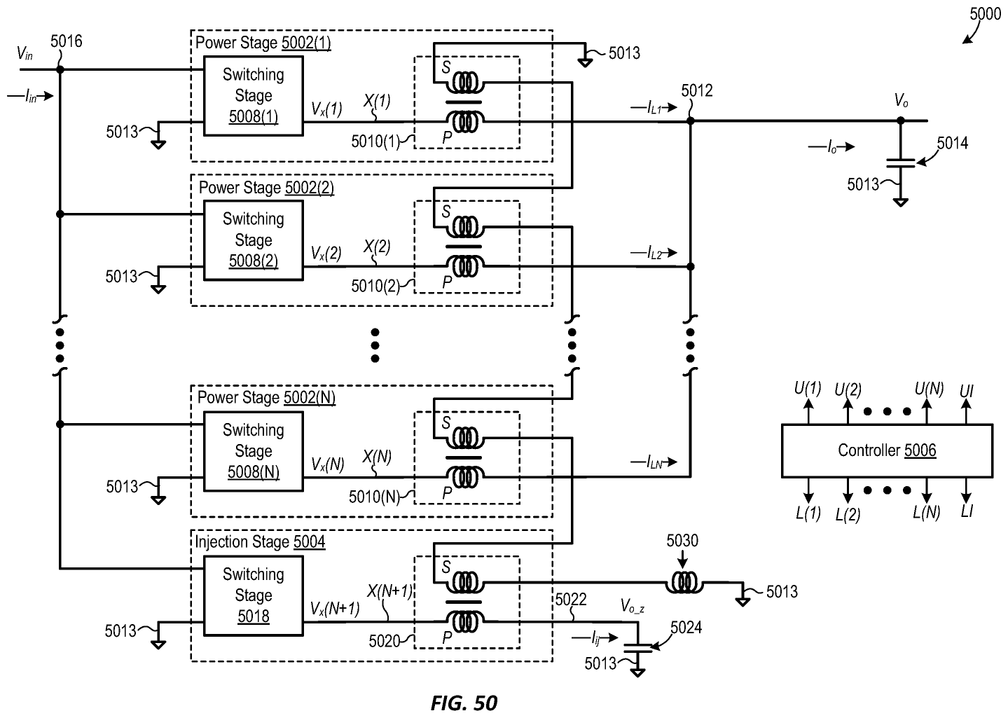

Applicant has additionally determined that use of injection in a switching power converter can also help reduce magnitude of ripple in output current. For example, FIG. 50 is a schematic diagram of a multi-phase switching power converter 5000 including transformers and an injection stage. Switching power converter 5000 includes N power stages 5002, an injection stage 5004, and a controller 5006, where N is an integer greater than one. Each power stage 5002 corresponds to a respective phase of switching power converter 5000, such that switching power converter 5000 is an N-phase switching power converter. In particular, power stage 5002(1) corresponds to a first phase of switching power converter 5000, power stage 5002(2) corresponds to a second phase of switching power converter 5000, as so on.

Each power stage 5002 includes a power switching stage 5008 and a power transformer 5010, where the power switching stage 5008 is electrically coupled to a primary winding P of the power transformer 5010 at a switching node X. The primary winding P of each power transformer 5010 is electrically coupled between the switching node X of its respective power stage 5002 and a common output node 5012. Output node 5012 has a voltage Vₒ, and an output current Iₒ flows to a load (not shown) electrically coupled to output node 5012. Output current Iₒ could have a negative polarity without departing from the scope hereof. One or more capacitors 5014 are optionally electrically coupled to output node 5012.

Each power switching stage 5008 is configured to repeatedly switch the switching node X of its power stage 5002 between an input power node 5016 and a reference node 5013, in response to control signals U and L generated by controller 5006. Specifically, power switching stage 5008(1) is configured to repeatedly switch node X(1) between input power node 5016 and ground in response to control signals U(1) and L(1), power switching stage 5008(2) is configured to repeatedly switch node X(2) between input power node 5016 and reference node 5013 in response to control signals U(2) and L(2), and so on. Input power node 5016 is at a voltage Vᵢₙ, and each power switching stage 5008 accordingly repeatedly switches node X of its power stage 5002 between voltage Vᵢₙ and zero volts relative to ground. An input current Iᵢₙ flows from an electrical power source (not shown) to switching power converter 5000 via input power node 5016. Input current Iᵢₙ could have a negative polarity without departing from the scope hereof. A primary winding P of a given power transformer 5010(1) in switching power converter 5000 is driven “high” when its respective switching node X is at voltage Vᵢₙ, and the primary winding P is driven “low” when its respective switching node X is at zero volts relative to reference node 5013. In certain embodiments, power switching stages 5008 are similar to switching stages 202 of FIG. 2. Reference node 5013 is depicted as being a ground node, such as an earth ground node or a chassis ground node. It is understood, though, that reference node 5013 need not be a ground node, and reference node 5013 accordingly could be at a different electrical potential than an earth ground or a chassis ground.

Injection stage 5004 includes an injection switching stage 5018 and an injection transformer 5020, where injection switching stage 5018 is electrically coupled to a primary winding P of injection transformer 5020 at a switching node X(N+1). Primary winding P of injection transformer 5020 is electrically coupled between switching node X(N+1) and injection output node 5022. Injection output node 5022, which is separate from output power node 5012, is at a voltage V_{o_z}, and one or more capacitors 5024 are electrically coupled to injection output node 5022. Injection switching stage 5018 is configured to repeatedly switch node X(N+1) between input power node 5016 and reference node 5013 in response to control signals UI and LI. Similar to primary windings P of power transformers 5010, primary winding P of injection transformer 5020 is driven high when switching node X(N+1) is at voltage Vᵢₙ, and primary winding P of injection transformer 5020 is driven low when switching node X(N+1) is at zero volts relative to reference node 5013. Injection stage 5004 does not handle a direct current component of output current Iₒ. Instead, controller 5006 controls injection stage 5004 to reduce, or even essentially eliminate, alternating current voltage across leakage inductances of power transformers 5010, as discussed below. In certain embodiments, injection switching stage 5018 is similar to an instance of switching stage 202 of FIG. 2.

Secondary windings S of power transformers 5010, as well as secondary winding S of injection transformer 5020, are electrically coupled in series with each other. While FIG. 50 depicts the series connections of secondary windings S being partially embodied by reference node 5013, secondary windings S could alternately be isolated from reference node 5013, as long as they are electrically coupled in series. An optional tuning inductor 5030 is electrically coupled in series with secondary windings S of power transformers 5010, as well as with secondary winding S of injection transformer 5020. The topological location of tuning inductor 5030 could vary as long as it is electrically coupled in series with secondary windings S. While tuning inductor 5030 is depicted as being a discrete inductor, tuning inductor 5030 could instead be embodied by intrinsic inductance of a circuit including secondary windings S, particularly in applications where tuning inductor 5030 need only have a small inductance value. Furthermore, tuning inductor 5030 could be omitted, or tuning inductor 5030 could be replaced with a plurality of tuning inductors, without departing from the scope hereof.

Controller 5006 is configured to generate control signals U and L to control duty cycle of power stages 5002, where duty cycle is a portion of a switching cycle that a primary winding P of a power transformer 5010 is driven high, to regulate at least one parameter of switching power converter 5000. Controller 5006 is configured to vary duty cycle of power stages 5002, for example, using a pulse width modulation technique and/or a pulse frequency modulation technique. Controller 5006 is optionally configured to generate control signals U and L such that power stages 5002 switch out-of-phase with each other.

Controller 5006 is further configured to generate control signals UI and LI to control injection stage 5004 such that the injection stage injects magnetic flux in each power transformer 5010 in a manner which reduces voltage across leakage inductance of each power transformer 5010. Such reduction in voltage across leakage inductances advantageously reduces, or even essentially eliminates, magnitude of ripple current associated with charging and discharging of leakage inductances. Not only does such collective operation of injection stage 5004 and controller 5006 reduce magnitude of ripple in each current I_{L} flowing through a respective power transfer winding P, it also reduces magnitude of ripple in output current Iₒ.

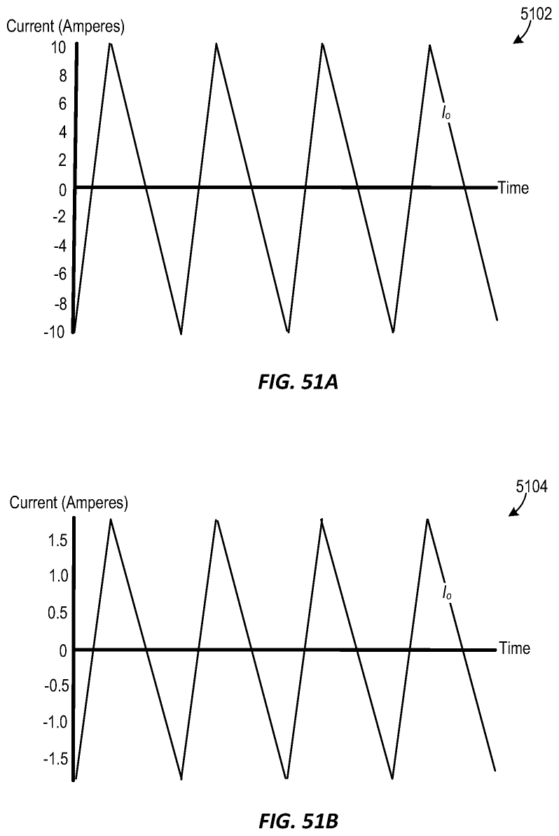

For example, FIG. 51A is a graph 5102 of output current Iₒ versus time illustrating simulated operation of an embodiment of switching power converter 5000 with injection stage 5004 disabled. Peak-to-peak magnitude of output current Iₒ is around 20 amperes with injection stage 5004 disabled, as illustrated in graph 5102. FIG. 51B is a graph 5104 of output current Iₒ versus time illustrating simulated operation of the same embodiment of switching power converter 5000 that is simulated in the FIG. 51A simulation but with injection stage 5004 enabled. Peak to peak magnitude of output current Iₒ is around 3.6 amperes with injection stage 5004 enabled, as illustrated in graph 5104. As such, operation of injection stage 5004 in switching power converter 5000 reduces magnitude of ripple in output current Iₒ by about 5.5 times, in the embodiment of switching power converter 5000 simulated in FIGS. 51A and 51B.

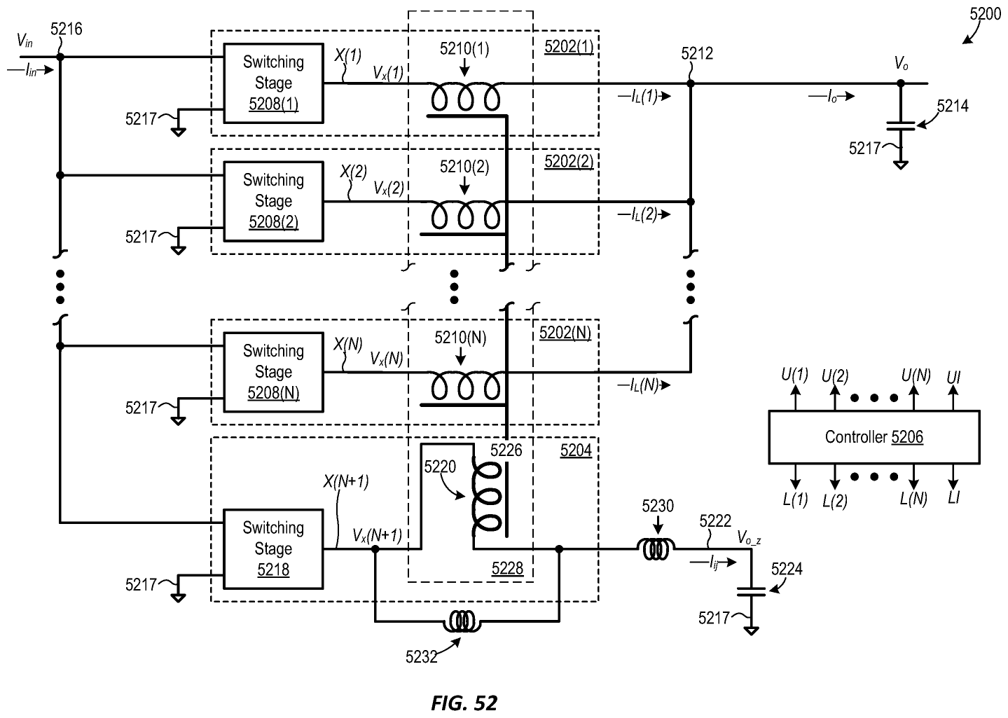

FIG. 52 is a schematic diagram of a multi-phase switching power converter 5200 including a boosted coupled inductors and an injection stage. Switching power converter 5200 includes N power stages 5202, an injection stage 5204, and a controller 5206, where Nis an integer greater than one. Each power stage 5202 corresponds to a respective phase of switching power converter 5200, such that switching power converter 5200 is an N-phase switching power converter.

Each power stage 5202 includes a power switching stage 5208 electrically coupled to a power transfer winding 5210 at a switching node X. Each power transfer winding 5210 is electrically coupled between the switching node X of its respective power stage 5202 and a common output node 5212. Output node 5212 has a voltage Vₒ, and an output current Iₒ flows to a load (not shown) electrically coupled to output node 5212. Output current Iₒ could have a negative polarity without departing from the scope hereof. One or more capacitors 5214 are optionally electrically coupled to output node 5212.

Each power switching stage 5208 is configured to repeatedly switch the switching node X of its power stage 5202 between an input power node 5216 and a reference node 5217, in response to control signals U and L generated by controller 5206. Specifically, power switching stage 5208(1) is configured to repeatedly switch node X(1) between input power node 5216 and reference node 5217 in response to control signals U(1) and L(1), power switching stage 5208(2) is configured to repeatedly switch node X(2) between input power node 5216 and ground in response to control signals U(2) and L(2), and so on. Input power node 5216 is at a voltage Vᵢₙ, and each power switching stage 5208 accordingly repeatedly switches node X of its power stage 5202 between voltage Vᵢₙ and zero volts relative to reference node 5217. Reference node 5217 is depicted as being a ground node, such as an earth ground node or a chassis ground node. It is understood, though, that reference node 5217 need not be a ground node, and reference node 5217 accordingly could be at a different electrical potential than an earth ground or a chassis ground. In certain embodiments, power switching stages 5208 are similar to switching stages 202 of FIG. 2. An input current Iᵢₙ flows from an electrical power source (not shown) to switching power converter 5200 via input power node 5216. Input current Iᵢₙ could have a negative polarity without departing from the scope hereof. A given power transfer winding 5210 in converter 5200 is driven “high” when its respective switching node X is at voltage Vᵢₙ, and the power transfer winding 5210 is driven “low” when its respective switching node X is at zero volts relative to reference node 5217.

Injection stage 5204 includes an injection switching stage 5218 electrically coupled to a boost winding 5220 at a switching node X(N+1). Boost winding 5220 is electrically coupled between switching node X(N+1) and injection output node 5222. Injection output node 5222, which is separate from output power node 5212, is at a voltage Vo_z, and one or more capacitors 5224 are electrically coupled to injection output node 5222, such that each capacitor 5224 is electrically coupled in series with boost winding 5220. A first tuning inductor 5230 is electrically coupled in series with boost winding 5220. Although first tuning inductor 5230 is illustrated as being electrically coupled between boost winding 5220 and capacitor 5224, first tuning inductor 5230 could be at a different topological location as long as it is electrically coupled in series with boost winding 5220. First tuning inductor 5230 is omitted in some alternate embodiments of switching power converter 5200, such as in embodiments where a circuit including boost winding 5220 has sufficient inductance such that first tuning inductor 5230 is not required. Switching power converter 5200 optionally further includes a second tuning inductor 5232 electrically coupled in parallel with boost winding 5220. Second tuning inductor 5232, when present, typically has a relatively large inductance value.

Injection switching stage 5218 is configured to repeatedly switch switching node X(N+1) between input power node 5216 and ground in response to control signals UI and LI. Similar to power transfer windings 5210, boost winding 5220 is driven high when switching node X(N+1) is at voltage Vᵢₙ, and boost winding 5220 is driven low when switching node X(N+1) is at zero volts relative to reference node 5217. Injection stage 5204 does not handle a direct current component of output current Iₒ. Instead, controller 5206 controls injection stage 5204 to reduce, or even essentially eliminate, alternating current voltage across leakage inductances of power transfer windings 5210, as discussed below, thereby reducing magnitude of ripple current flowing through power transfer windings 5210, as well as reducing magnitude of ripple in output current Iₒ. In certain embodiments, injection switching stage 5218 is similar to an instance of switching stage 202 of FIG. 2.

Power transfer windings 5210 are magnetically coupled by a magnetic core 5226. Boost winding 5220 is magnetically coupled to a leakage component (not illustrated in FIG. 52) of each power transfer winding 5210 by magnetic core 5226. In particular, boost winding 5220 is configured such that it forms at least one turn around a respective leakage magnetic flux path of each power transfer winding 5210. Importantly, boost winding 5220 is additionally configured such that net mutual magnetic flux within the turns of the boost winding is essentially zero during steady state operation of switching power converter 5200. Such configuration of boost winding 5220 advantageously helps minimize risk of a magnetic saturation from mutual magnetic flux within a magnetic flux path of boost winding 5220 while enabling injection stage 5204 to reduce ripple current magnitude in switching power converter 5200. Power transfer windings 5210, boost winding 5220, and magnetic core 5226 are part of a boosted coupled inductor 5228. In certain embodiments, boosted coupled inductor 5228 is configured similar to one of the boosted coupled inductors discussed above with respect to FIGS. 9-29.

Controller 5206 is configured to generate control signals U and L to control duty cycle of power stages 5202, where duty cycle is a portion of a switching cycle that a power transfer winding 5210 is driven high, to regulate at least one parameter of switching power converter 5200. In some embodiments, controller 5206 is configured to control duty cycle of power stages 5202 using pulse width modulation and/or pulse frequency modulation. Examples of possible regulated parameters include, but are not limited, magnitude of input voltage Vᵢₙ, magnitude of input current Iᵢₙ, magnitude of output voltage Vₒ, and magnitude of output current Iₒ. Controller 5206 is optionally configured to generate control signals U and L such that power stages 5202 switch out-of-phase with each other.

Controller 5206 is further configured to generate control signals UI and LI to control injection stage 5204 such that the injection stage injects magnetic flux in magnetic core 5226 in a manner which reduces voltage across leakage inductances of power transfer windings 5210. Such reduction in voltage across leakage inductance of power transfer windings 5210 advantageously reduces, or even essentially eliminates, magnitude of ripple current associated with charging and discharging of the leakage inductance, thereby reducing magnitude of ripple current flowing through power transfer windings 5210, as well as reducing magnitude of ripple in output current Iₒ.

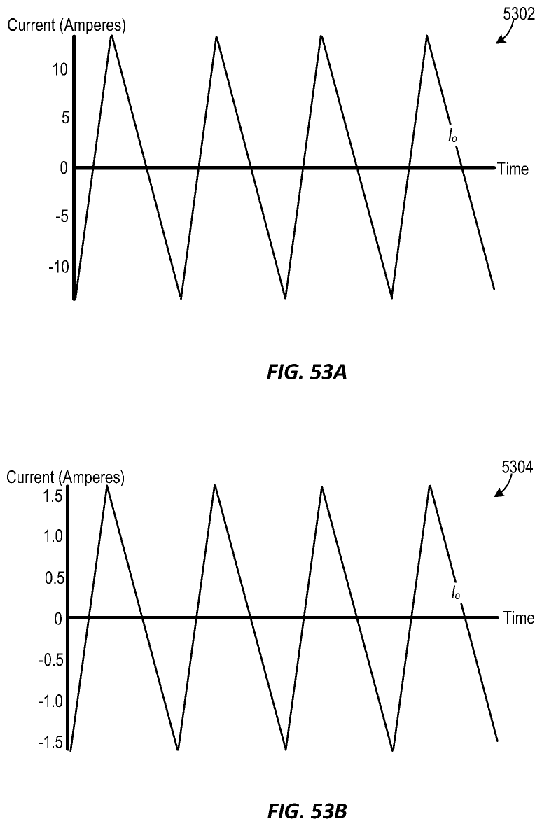

For example, FIG. 53A is a graph 5302 of output current Iₒ versus time illustrating simulated operation of an embodiment of switching power converter 5200 with injection stage 5204 disabled. Peak-to-peak magnitude of output current Iₒ is around 26 amperes with injection stage 5204 disabled, as illustrated in graph 5302. FIG. 53B is a graph 5304 of output current Iₒ versus time illustrating simulated operation of the same embodiment of switching power converter 5200 that is simulated in the FIG. 53A simulation but with injection stage 5204 enabled. Peak to peak magnitude of output current Iₒ is around 3.6 amperes with injection stage 5204 enabled, as illustrated in graph 5304. As such, operation of injection stage 5204 in switching power converter 5200 reduces magnitude of ripple in output current Iₒ by about 8.1 times, in the embodiment of switching power converter 5200 simulated in FIGS. 53A and 53B.

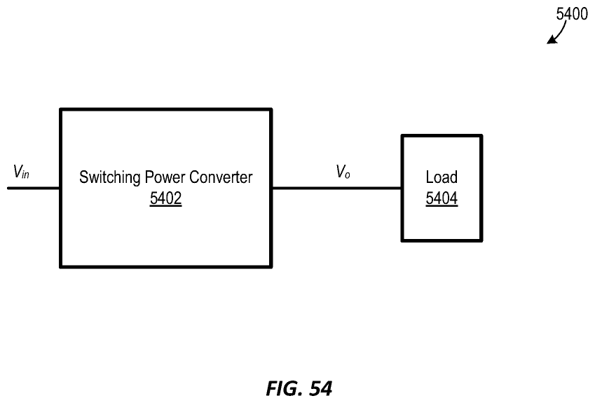

FIG. 54 is a block diagram of an electrical system 5400, which is one possible application of the new switching power converters disclosed herein. System 5400 includes a switching power converter 5402 configured to power a load 5404. Switching power converter 5402 may be any one of the new switching power converters disclosed herein. For example, switching power converter 5402 may be any one of switching power converters 100, 600, 800, 3200, 3800, 3900, 4900, 5000, or 5200. Load 5404 includes, for example, one or more integrated circuits, including but not limited to, a processing unit (e.g. a central processing unit (CPU) or a graphics processing unit (GPU)), a field programmable gate array (FPGA), an application specific integrated circuit (ASIC) (e.g. for artificial intelligence and/or machine learning), and/or a memory unit.

### Combinations of Features

Features described above may be combined in various ways without departing from the scope hereof. The following examples illustrate some possible combinations.

(A1) A switching power converter includes (i) a plurality of power stages, each power stage including a respective power transformer, and (ii) a blocking capacitor. The blocking capacitor and a respective secondary winding of each power transformer are electrically coupled in series between an output power node of the switching power converter and a reference node of the switching power converter.

(A2) The switching power converter denoted as (A1) may further include a tuning inductor electrically coupled in series with the injection capacitor and the respective secondary winding of each power transformer.

(A3) Either one of the switching power converters denoted as (A1) or (A2) may further include a controller configured to control duty cycle of the plurality of power stages to regulate at least one parameter of the switching power converter.

(A4) In any one of the switching power converters denoted as (A1) through (A3), each power transformer may include a respective primary winding electrically coupled to the output power node of the switching power converter.

(A5) The switching power converter denoted as (A4) may be configured such that current flowing through the secondary windings of the power transformers at least partially cancels ripple current flowing through the primary windings of the power transformers, at the output power node of the switching power converter.

(A6) The switching power converter denoted as (A4) may be configured such that current flowing through the secondary windings of the power transformers adds to alternating current flowing through the primary windings of the power transformers, at the output power node of the switching power converter.

(A7) In any one of the switching power converters denoted as (A4) through (A6), each power stage may further include a respective switching stage electrically coupled electrically coupled to the primary winding of the respective power transformer of the power stage.

(A8) Any one the switching power converters denoted as (A1) through (A7) may have a buck-type topology.

(B1) A switching power converter includes a first power stage, a second power stage, and a blocking capacitor. The first power stage includes (i) a first switching stage and (ii) a first power transformer including a first primary winding and a first secondary winding, where the first primary winding is electrically coupled between the first switching stage and an output power node of the switching power converter. The second power stage includes (i) a second switching stage and (ii) a second power transformer including a second primary winding and a second secondary winding, where the second primary winding is electrically coupled between the second switching stage and the output power node of the switching power converter. The blocking capacitor, the first secondary winding, and the second secondary winding are electrically coupled in series between the output power node of the switching power converter and a reference node of the switching power converter.

(B2) The switching power converter denoted as (B1) may further include the third power stage, where the third power stage includes a third switching stage and a third power transformer. The third power transformer includes a third primary winding and a third secondary winding, where the third primary winding is electrically coupled between the third switching stage and the output power node of the switching power converter. The blocking capacitor, the first secondary winding, the second secondary winding, and the third secondary winding may be electrically coupled in series between the output power node of the switching power converter and the reference node of the switching power converter.

(B3) Either one of the switching power converters denoted as (B1) or (B2) may further include a controller, where the controller being configured to control at least the first switching stage and the second switching stage to regulate at least one parameter of the switching power converter.

(C1) A switching power converter includes (i) a plurality of power stages, each power stage including a respective power transfer winding, (ii) a boost winding forming at least one turn around a respective leakage magnetic flux path of each power transfer winding, and (iii) a blocking capacitor. The blocking capacitor and the boost winding may be electrically coupled in series between an output power node of the switching power converter and a reference node of the switching power converter.

(C2) The switching power converter denoted as (C1) may further include a controller configured to control duty cycle of the plurality of power stages to regulate at least one parameter of the switching power converter.

(C3) In the switching power converter denoted as (C1), each power stage may further include a respective switching stage electrically coupled to the respective power transfer winding of the power stage.

(C4) The switching power converter denoted as (C3) may further include a controller configured to control the respective switching stage of each power stage to regulate at least one parameter of the switching power converter.

(C5) Any one of the switching power converters denoted as (C1) through (C4) may further include a tuning inductor electrically coupled in series with the blocking capacitor and the boost winding.

(C6) Any one of the switching power converters denoted as (C1) through (C5) may be configured such that current flowing through the boost winding at least partially cancels ripple current flowing through the power transfer windings of the power stages, at the output power node of the switching power converter.

(C7) Any one of the switching power converters denoted as (C1) through (C5) may be configured such that current flowing through the boost winding adds to alternating current flowing through the power transfer windings of the power stages, at the output power node of the switching power converter.

(C8) Any one of the switching power converters denoted as (C1) through (C7) may have a buck-type topology.

(C9) Any one of the switching power converters denoted as (C1) through (C8) may further include a transformer, where the boost winding is electrically coupled in series with the blocking capacitor via the transformer.

(D1) A switching power converter includes a first power stage, a second power stage, a boost winding, and a blocking capacitor. The first power stage includes (i) a first switching stage and (ii) a first power transfer winding electrically coupled between the first switching stage and an output power node of the switching power converter. The second power stage includes (i) a second switching stage and (ii) a second power transfer winding electrically coupled between the second switching stage and the output power node of the switching power converter. The boost winding forms at least one turn around a respective leakage magnetic flux path of at least the first power transfer winding and the second power transfer winding. The blocking capacitor and the boost winding are electrically coupled in series between the output power node of the switching power converter and a reference node of the switching power converter.

(D2) The switching power converter denoted as (D1) may further include a third power stage, where the third power stage includes (i) a third switching stage and (ii) a third power transfer winding electrically coupled between the third switching stage and the output power node of the switching power converter. The boost winding may further form at least one turn around a leakage magnetic flux path of the third power transfer winding.

(D3) Either of the switching power converters denoted (D1) or (D2) may further include a controller, where the controller is configured to control at least the first switching stage and the second switching stage to regulate at least one parameter of the switching power converter.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. A switching power converter, comprising:
a plurality of power stages, each power stage including a respective power transformer; and
a blocking capacitor;
wherein the blocking capacitor and a respective secondary winding of each power transformer are electrically coupled in series between an output power node of the switching power converter and a reference node of the switching power converter.

2. The switching power converter of claim 1, further comprising a tuning inductor electrically coupled in series with the injection capacitor and the respective secondary winding of each power transformer.

3. The switching power converter of claim 1, further comprising a controller configured to control duty cycle of the plurality of power stages to regulate at least one parameter of the switching power converter.

4. The switching power converter of claim 1, wherein each power transformer includes a respective primary winding electrically coupled to the output power node of the switching power converter.

5. The switching power converter of claim 4, wherein the switching power converter is configured such that current flowing through the secondary windings of the power transformers at least partially cancels ripple current flowing through the primary windings of the power transformers, at the output power node of the switching power converter.

6. The switching power converter of claim 4, wherein the switching power converter is configured such that current flowing through the secondary windings of the power transformers adds to alternating current flowing through the primary windings of the power transformers, at the output power node of the switching power converter.

7. The switching power converter of claim 4, wherein each power stage further includes a respective switching stage electrically coupled to the primary winding of the respective power transformer of the power stage.

8. The switching power converter of claim 1, wherein the switching power converter has a buck-type topology.

9. A switching power converter, comprising:
a first power stage, the first power stage including:
a first switching stage,
a first power transformer including a first primary winding and a first secondary winding, the first primary winding being electrically coupled between the first switching stage and an output power node of the switching power converter;
a second power stage, the second power stage including:
a second switching stage,
a second power transformer including a second primary winding and a second secondary winding, the second primary winding being electrically coupled between the second switching stage and the output power node of the switching power converter; and
a blocking capacitor;
wherein the blocking capacitor, the first secondary winding, and the second secondary winding are electrically coupled in series between the output power node of the switching power converter and a reference node of the switching power converter.

10. The switching power converter of claim 9, further comprising a third power stage, the third power stage including:
a third switching stage; and
a third power transformer including a third primary winding and a third secondary winding, the third primary winding being electrically coupled between the third switching stage and the output power node of the switching power converter;
wherein the blocking capacitor, the first secondary winding, the second secondary winding, and the third secondary winding are electrically coupled in series between the output power node of the switching power converter and the reference node of the switching power converter.

11. The switching power converter of claim 9, further comprising a controller, the controller being configured to control at least the first switching stage and the second switching stage to regulate at least one parameter of the switching power converter.

12. A switching power converter, comprising:
a plurality of power stages, each power stage including a respective power transfer winding;
a boost winding forming at least one turn around a respective leakage magnetic flux path of each power transfer winding; and
a blocking capacitor;
wherein the blocking capacitor and the boost winding are electrically coupled in series between an output power node of the switching power converter and a reference node of the switching power converter.

13. The switching power converter of claim 12, further comprising a controller configured to control duty cycle of the plurality of power stages to regulate at least one parameter of the switching power converter.

14. The switching power converter of claim 12, wherein each power stage further includes a respective switching stage electrically coupled to the respective power transfer winding of the power stage.

15. The switching power converter of claim 14, further comprising a controller configured to control the respective switching stage of each power stage to regulate at least one parameter of the switching power converter.

16. The switching power converter of claim 12, further comprising a tuning inductor electrically coupled in series with the blocking capacitor and the boost winding.

17. The switching power converter of claim 12, wherein the switching power converter is configured such that current flowing through the boost winding at least partially cancels ripple current flowing through the power transfer windings of the power stages, at the output power node of the switching power converter.

18. The switching power converter of claim 12, wherein the switching power converter is configured such that current flowing through the boost winding adds to alternating current flowing through the power transfer windings of the power stages, at the output power node of the switching power converter.

19. The switching power converter of claim 12, wherein the switching power converter has a buck-type topology.

20. The switching power converter of claim 12, further comprising a transformer, wherein the boost winding is electrically coupled in series with the blocking capacitor via the transformer.
